(19) United States
(12) Patent Application Publication
(10) Pub. No.: US 2026/0259728 A1
(43) Pub. Date: Sep. 3, 2026

(54) HMI CONTROL DEVICE AND MANAGEMENT SYSTEM

(71) Applicant: DENSO CORPORATION, Kariya-city (JP)

(72) Inventors: Takuya KUME, Kariya-city (JP); Kazuki IZUMI, Kariya-city (JP); Atsushi BABA, Kariya-city (JP)

(21) Appl. No.: 19/657,660

(22) Filed: Apr. 24, 2026

Related U.S. Application Data
(63) Continuation of application No. PCT/JP2024/038620, filed on Oct. 30, 2024.

(30) Foreign Application Priority Data
Nov. 2, 2023 (JP) 2023-188842

(51) Int. Cl. G06F 8/65

(52) U.S. Cl. CPC G06F 8/65

(57) ABSTRACT

A software management unit as an HMI control device is communicably connected to an HMI device used by a vehicle user, and includes at least one processor. The processor acquires information on verification and validation of new software that can be used in a vehicle system. The processor notifies the vehicle user of the information on verification and validation using the HMI device along with application of the new software to the vehicle system.

### CROSS REFERENCE TO RELATED APPLICATIONS

The present application is a continuation application of International Patent Application No. PCT/JP2024/038620 filed on October 30, 2024, which designated the U.S. and claims the benefit of priority from Japanese Patent Application No. 2023-188842 filed on November 2, 2023. The entire disclosures of all of the above applications are incorporated herein by reference.

### TECHNICAL FIELD

The disclosure in this description relates to management of software used in a vehicle system.

### BACKGROUND

In a related art, a vehicle user is inquired, using an HMI, about whether software for control of an automated vehicle/autonomous vehicle can be updated. At this time, a simple description indicating update content of the software is displayed on a display device.

### SUMMARY

According to an aspect of the present disclosure, a human machine interface control device, which is communicably connected to a human machine interface device to be used by a vehicle user, includes at least one of (i) a circuit and (ii) a processor with a memory storing computer program code executable by the processor. The at least one of the circuit and the processor may be configured to acquire information on verification and validation of new software that is usable in a vehicle system, and notify, along with application of the new software to the vehicle system, the vehicle user of the information on verification and validation using the human machine interface device.

### BRIEF DESCRIPTION OF DRAWINGS

The present disclosure will become apparent from the following detailed description made with reference to the accompanying drawings. In the drawings:

FIG. 1 is a diagram illustrating an example of a hardware configuration of a driving system or the like;

FIG. 2 is a diagram illustrating a functional configuration of the driving system;

FIG. 3 is a diagram illustrating an example of a configuration of a cockpit;

FIG. 4 is a diagram illustrating an example of a schematic configuration of a management system;

FIG. 5 is a flowchart illustrating a test conduction process;

FIG. 6 is a flowchart illustrating an update process;

FIG. 7 is a diagram illustrating an example of a notification using an HMI;

FIG. 8 is a diagram illustrating an example of a notification using an HMI;

FIG. 9 is a diagram illustrating an example of a notification using an HMI;

FIG. 10 is a flowchart illustrating an update process;

FIG. 11 is a flowchart illustrating an update process;

FIG. 12 is a flowchart illustrating an update process;

FIG. 13 is a flowchart illustrating a process during conduction of a test;

FIG. 14 is a flowchart illustrating an update process;

FIG. 15 is a flowchart illustrating an update process;

FIG. 16 is a flowchart illustrating an update process;

FIG. 17 is a diagram illustrating an example of a notification using an HMI;

FIG. 18 is a diagram illustrating an example of a notification using an HMI;

FIG. 19 is a diagram illustrating an example of a notification using an HMI;

FIG. 20 is a flowchart illustrating an update process;

FIG. 21 is a flowchart illustrating a training process;

FIG. 22 is a diagram illustrating an example of a schematic configuration of a management system;

FIG. 23 is a diagram illustrating an example of a notification using an HMI;

FIG. 24 is a flowchart illustrating an update process;

FIG. 25 is a diagram illustrating an example of a hardware configuration of a processing system; and

FIG. 26 is a diagram illustrating an example of a hardware configuration of the processing system.

### DETAILED DESCRIPTION

In a vehicle system according to the above-described related art, it is difficult for the vehicle user to sufficiently understand content of the new software such as updated software. Therefore, it is required to allow the vehicle user to correctly perceive the validity of the new software, to enhance the reliability in a vehicle system, and to use the vehicle system at ease.

According to an aspect of the present disclosure, a human machine interface control device, which is communicably connected to a human machine interface device to be used by a vehicle user, includes at least one of (i) a circuit and (ii) a processor with a memory storing computer program code executable by the processor. The at least one of the circuit and the processor may be configured to acquire information on verification and validation of new software that is usable in a vehicle system, and notify, along with application of the new software to the vehicle system, the vehicle user of the information on verification and validation using the human machine interface device.

According to another aspect of the present disclosure, a management system for managing vehicle software is provided. The vehicle software is used in a vehicle system. The management system includes multiple vehicles each equipped with the vehicle system, and a server communicably connected to the multiple vehicles. The server is configured to: execute a process related to verification and validation of the software usable in the vehicle system; generate information on verification and validation of the software based on the process related to verification and validation; and transmit the information on verification and validation of the software to each of the plurality of vehicles along with distribution of new software, the new software being determined to be formally distributed to each of the plurality of vehicles based on execution of the process related to verification and validation. The vehicle system equipped in at least one of the multiple vehicles is configured to: acquire the information on verification and validation; and, along with application of the new software to the vehicle system, notify a vehicle user of the information on verification and validation using a human machine interface device that is used by the vehicle user.

According to the above aspects, the vehicle user can acquire information on V&V of the new software through the HMI device. The vehicle user can perceive the validity of the new software used in the vehicle system through the information on V&V. Therefore, the reliability of the vehicle user in the vehicle system can be enhanced, and the vehicle system can be used at ease.

Hereinafter, multiple embodiments will be described based on the drawings. Duplicate descriptions may be omitted by assigning the same reference numerals to the corresponding elements in each embodiment. When only a part of the configuration is described in each embodiment, the configurations of the other embodiments described above can be applied to the other parts of the configuration. In addition, configurations specified in the description of each embodiment can be combined, and especially, configurations of multiple embodiments can be partially combined even though not specified here so long as no problem occurs in the combination thereof.

In the following multiple embodiments, the contents of "Safety First for Automated Driving" Tech. Rep., 2019, by Aptiv, Audi, Baidu, BMW, Continental, Daimler, FCA, here, Infineon, Intel, and Volkswagen, contents of ISO 21448:2022, and contents of IEEE 2846-2022 are incorporated by reference in their entirety.

### Description of Terms

The following describes terms related to this disclosure in this description. This description is included in the embodiments of this disclosure.

A road user may be a traffic participant on or adjacent to an active road for the purpose of moving from a certain place to another place.

A dynamic driving task (DDT) may be a real-time operation functionality and a real-time strategic functionality for operating a vehicle in traffic. The dynamic driving task may be all real-time operation functionalities and real-time strategic functionalities for operating the vehicle on the road.

An automated driving system (ADS) may be a batch of hardware and software capable of continuously executing the entire DDT regardless of whether the automated driving system is limited to a specific operational design domain.

ADS functionality (ADS feature) may be a design-specific functionality of the ADS in a specific ODD at a predetermined automated driving level.

A DDT fallback may be a response by a driver or an automated system to either execute a DDT or transition to a minimal risk condition after a failure occurs or upon detection of a functional insufficiency or a potentially hazardous behavior. The DDT fallback may be a method of transition control from autonomy to control by a driver or other system using takeover/fallback states and associated use cases. The DDT fallback may be a response by the user for executing the DDT or achieving an MRC after the occurrence of a system failure related to the DDT capability or during deviation from the ODD, or a response by the ADS for achieving the MRC when placed in the same situation.

The minimal risk condition (MRC) may be a vehicle state in order to reduce the risk, when a predetermined trip cannot be completed. The minimal risk condition may be a stable stop state that the user or the ADS brings to the vehicle after the DDT fallback is executed in order to reduce the risk of an accident when the predetermined trip cannot or should not be continued.

The operational design domain (ODD) may be a specific condition which is designed such that a predetermined (automated) driving system functions. The operational design domain is an operation condition specially designed such that a predetermined ADS or a functionality thereof functions, and includes, but is not limited to, the presence or absence of requirements of environmental, geography, and time zone restrictions, and/or certain traffic/road properties.

Safety of the intended functionality (SOTIF) may be the absence of unreasonable risks due to inadequacy of the intended functionality or the implementation functionality thereof.

A driving policy may be a strategy and a rule defining a control action at a vehicle level.

A situation is a factor that can affect a behavior of a system, and may include traffic situations, weather, and a behavior of an ego-vehicle.

A scenario may be a description of the temporal relationships between several scenes in a series of scenes, including goals and values in a specific situation influenced by actions and events. The scenario may be a description of consecutive activities in time series in which a vehicle as a main object, all external environments thereof, and interactions thereof in a process of executing a specific driving task are integrated.

A safety-relevant object may be any moving or static object that may be relevant to the safety capability of the DDT.

The term "reasonably foreseeable" may mean being technically reliable and having a credible or measurable occurrence rate.

A triggering condition may be a specific condition of a scenario functioning as a trigger for a response that is a response of a subsequent system and that contributes to inability to prevent, detect, and reduce hazardous behaviors and reasonably foreseeable indirect misuse.

The minimal risk maneuver (MRM) may be a movement of the vehicle instructed by the automated driving system during the DDT fallback to achieve the MRC.

The risk acceptance criteria/criterion are/is criteria/a criterion indicating that there is no unreasonable level of risk, and may be, for example, a physical parameter defining when a specific behavior is regarded as an unsafe behavior, the maximum number of accidents per hour, the lowest level that is reasonably executable, or the like.

A proper response may be an action that is significant to avoid and ameliorate a hazardous situation in a reasonably foreseeable scenario in which other safety-relevant objects are operating within an assumption range.

The safety-related model may be representation of a safety-related aspect of the driving action based on assumptions on the reasonably foreseeable behavior of other road users. The safety-related model may be an on-board or off-board checker or an on-board or off-board safety analysis device, a mathematical model, a set of more conceptual rules, a set of scenario-based behavior, or a combination thereof.

A formal model may be a model represented in a formal representation used for system capability verification.

A safety envelope may be a set of restrictions and conditions that are designed for a (automated) driving system to operate as a target for a constraint or a control in order to maintain an operation at an acceptable risk level. The safety envelope may be a general concept that can be used to deal with all principles on which the driving policy can be based. According to this concept, an ego-vehicle operated by the (automated) driving system can have one or multiple boundaries around the ego-vehicle.

The verification may be an activity for determining that the operation of the vehicle equipped with the (autonomous) driving system achieves the safety of the (autonomous) driving system application defined in the intended environment.

The validation may be an activity for determining that an inspection object satisfies a designated requirement.

The positive risk balance may be a criterion to demonstrate that a technical solution achieves an acceptable level of residual risk.

The object and event detection and response (OEDR) may be a sub-task of the DDT including monitoring the driving environment and executing an appropriate response to such an object or event.

A response time may be a time required for the road user to sense a specific stimulus and start executing a response (braking, steering, acceleration, stopping, or the like) in a predetermined scenario.

### First Embodiment

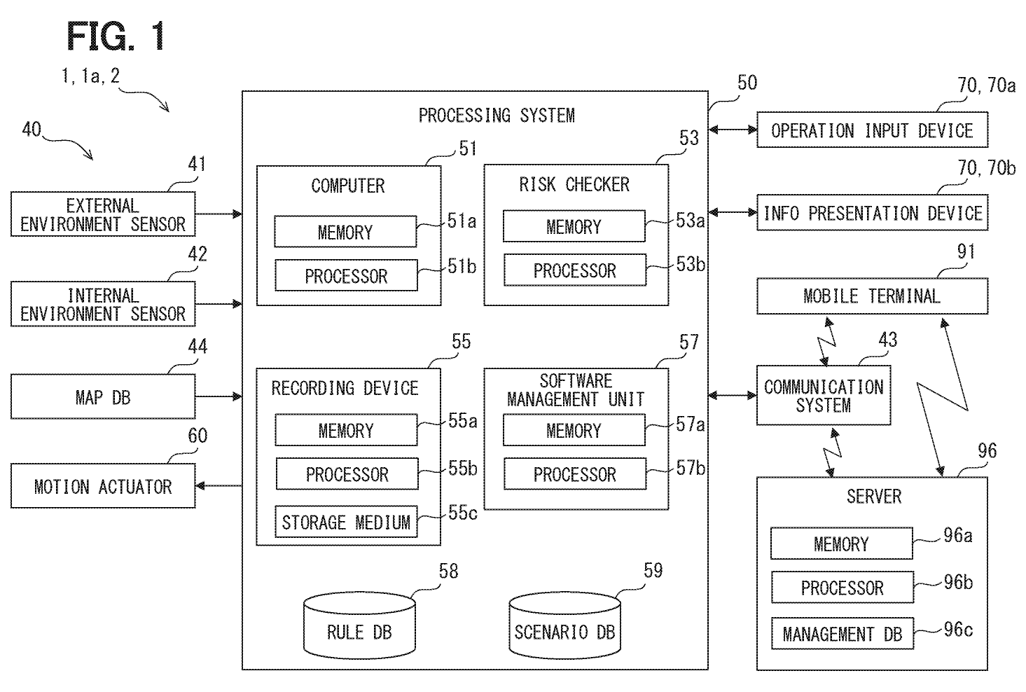

A driving system 2 of a first embodiment illustrated in FIG. 1 implements functionalities related to driving a vehicle 1. The driving system 2 may be a vehicle system 1a itself or may be a component forming a part of the vehicle system 1a. A part or all of the driving system 2 is mounted on the vehicle 1. This vehicle 1 may be referred to as an ego-vehicle, a host vehicle, or the like. The vehicle 1 may be able to communicate with another vehicle or the like directly or indirectly via a communication infrastructure. The other vehicle is referred to as a target vehicle in some cases.

The vehicle 1 may be, for example, a road user capable of executing manual driving of a four-wheeled automobile or a truck. The vehicle 1 may further be capable of executing automated driving. The automated driving may be referred to as autonomous driving by the driving system 2. Levels of the driving are classified in accordance with a range or the like of tasks executed by a human driver, among all dynamic driving tasks (DDTs). The automation level is defined, for example, in SAE J3016. At levels 0 to 2, the driver performs a part or all of the DDT. Levels 0 to 2 may be classified as so-called manual driving. Level 0 indicates that driving is not automated. Level 1 indicates that the driving system 2 supports the driver. Level 2 indicates that driving is partially automated.

At level 3 or higher, the driving system 2 performs the entire DDT while the ADS functionality (ADS feature) is operating. Levels 3 to 5 may be classified as so-called automated driving. Systems capable of executing driving at level 3 or higher may be referred to as automated driving systems (ADS). A vehicle on which an automated driving system is mounted or a vehicle capable of executing driving at level 3 or higher may be referred to as an automated vehicle/autonomous vehicle (AV).

Level 3 indicates that driving is conditionally automated. The automated driving system at level 3 executes the DDT but does not execute the DDT fallback. That is, the DDT fallback is executed by a driver who is ready for fallback. Level 4 indicates that driving is highly automated. The automated driving system at level 4 executes the DDT and the DDT fallback. The automated driving system at level 4 can cause the driver to take over the DDT after reaching the minimal risk condition (MRC) by executing the DDT fallback or the like. Level 5 indicates that driving is fully automated. The takeover of the DDT between the driving system 2 and the human driver is also referred to as authority transfer.

The conditions for executing automated driving at levels 3 and 4 may include some or all of the conditions indicated by the operational design domain (ODD). For example, the ADS functionality may be defined within the range of ODD. The driving system 2 described in the present embodiment is a driving system capable of executing automated driving at level 3 or higher.

The driving system 2 provides a functionality such as automated driving to a vehicle user. For example, the vehicle user may be a driver in the vehicle 1. The vehicle user may be an occupant in the vehicle 1. For example, when the vehicle is a personally owned vehicle (POV), the vehicle user may be an owner who owns the vehicle 1. For example, when the vehicle 1 is used for mobility as a service (MaaS), the vehicle user may be an operation administrator who manages the operation of the vehicle 1.

### Driving System

An architecture of the driving system 2 is selected such that a safety of the intended functionality (SOTIF) process can be implemented. For example, the architecture of the driving system 2 may be configured based on a sense-plan-act model. The sense-plan-act model includes a sense element, a plan element, and an act element, as main system elements. The sense element, the plan element, and the act element interact with one another. The sense may be replaced with perception, the plan may be replaced with determination, and the act may be replaced with control, respectively.

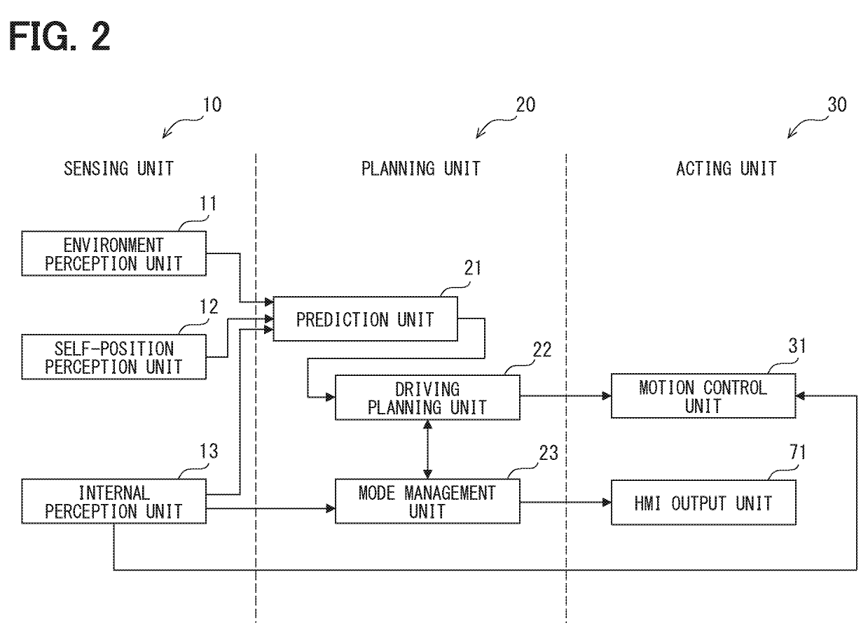

In such driving system 2, at a technical level (in other words, a technical perspective), at least multiple sensors 40 corresponding to the sensing functionality, at least one processing system 50 corresponding to the planning functionality, and multiple motion actuators 60 corresponding to the acting functionality are implemented. In the functionality level (in other words, a functional viewpoint), a sensing functionality, a planning functionality, and an acting functionality are implemented (also see FIG. 2).

Specifically, a sensing unit 10 as a functional block for implementing the sensing functionality mainly using the multiple sensors 40, a processing system 50 that processes sense information of the multiple sensors 40, and a processing system 50 that generates an environment model based on information of the multiple sensors 40 may be constructed in the driving system 2. A planning unit 20 and a risk checking unit 26 as functional blocks that implement the planning functionality mainly using the processing system 50 may be constructed in the driving system 2. An acting unit 30 as a functional block for implementing the acting functionality mainly using multiple motion actuators 60 and at least one processing system 50 that outputs an operation signal of the multiple motion actuators 60 may be constructed in the driving system 2.

The sensing unit 10 may be implemented in a form of a sensing system serving as a subsystem that is provided to be distinguishable from the planning unit 20 and the acting unit 30. The planning unit 20 may be implemented in a form of a planning system as a subsystem that is provided to be distinguishable from the sensing unit 10 and the acting unit 30. The planning system may include the risk checking functionality. The risk checking functionality may be mounted on the driving system 2 independently of the sensing unit 10, the planning unit 20, and the acting unit 30. The acting unit 30 may be implemented in a form of an acting system serving as a subsystem that is provided to be distinguishable from the sensing unit 10 and the planning unit 20. The sensing system, the planning system, and the acting system may form independent components. The subsystem here may be replaced with a module, a unit, a device, or the like.

The sensing unit 10 serves as the sensing functionality including localization (for example, estimation of position) of a road user such as the vehicle 1 and another vehicle. The sensing unit 10 senses an external environment, an internal environment, and a vehicle state of the vehicle 1, and further, senses a state of the driving system 2. The sensing unit 10 fuses the sensed information to generate an environment model. The environment model may be referred to as a world model. The planning unit 20 applies a purpose and a driving policy to the environment model generated by the sensing unit 10 to derive a control action. The acting unit 30 executes the control action derived by the planning unit 20.

### Physical Architecture

An example of a physical architecture of the driving system 2 will be described by using FIG. 1. The driving system 2 includes the multiple sensors 40, the multiple motion actuators 60, multiple HMI devices 70, and at least one processing system 50. These elements can communicate with each other through one or both of a wireless connection and a wired connection. These elements may be capable of communicating with each other through, for example, an in-vehicle network such as a CAN (registered trademark).

The multiple sensors 40 include one or multiple external environment sensors 41. The multiple sensors 40 may include at least one type among one or multiple internal environment sensors 42, one or multiple communication systems 43, and a map database (DB) 44.

The external environment sensor 41 may detect a target object present in the external environment of the vehicle 1. Examples of the external environment sensor 41 of a target object detection type include a camera, a light detection and ranging/laser imaging detection and ranging (LiDAR), a laser radar, a millimeter wave radar, an ultrasonic sonar, and the like. Typically, a combination of multiple types of external environment sensors 41 may be mounted to monitor directions including a front direction, a side direction, and a rear direction of the vehicle 1.

The external environment sensor 41 may detect a state of an atmosphere or a state of weather in the external environment of the vehicle 1. The external environment sensor 41 of a state detection type is, for example, an outside air temperature sensor, a temperature sensor, or a raindrop sensor.

The internal environment sensor 42 may detect a specific physical quantity (hereafter, a motion physical quantity) related to a vehicle motion in the internal environment of the vehicle 1. Examples of the internal environment sensor 42 of a motion physical quantity detection type include a velocity sensor, an acceleration sensor, a gyro sensor, and the like. The internal environment sensor 42 may detect a state of an occupant in the internal environment of the vehicle 1. The internal environment sensor 42 of an occupant detection type is, for example, an actuator sensor, a sensor monitoring a vehicle user (for example, a driver) and a system thereof, a biometric sensor, a seating sensor, or an in-vehicle device sensor. In particular, examples of the actuator sensor include an accelerator sensor, a brake sensor, a steering sensor, and the like that detect an operation state of the occupant with respect to the motion actuator 60 related to motion control of the vehicle 1.

The communication system 43 acquires communication data usable in the driving system 2 through wireless communication. The communication system 43 may receive a positioning signal from an artificial satellite of a global navigation satellite system (GNSS) present in the external environment of the vehicle 1. A communication device of a positioning type in the communication system 43 is, for example, a GNSS receiver.

The communication system 43 may transmit and receive communication signals to and from an external system (for example, a server 96) present in the external environment of the vehicle 1. A communication device of a V2X type in the communication system 43 is, for example, a dedicated short range communications (DSRC) communication device, or a cellular V2X (C-V2X) communication device. Examples of the communication with a V2X system present in the external environment of the vehicle 1 include communication with a communication system of another vehicle (V2V), communication with infrastructure such as a communication device set in a traffic light or a roadside device (V2I), communication with a mobile terminal of a pedestrian (V2P), communication with a network such as a cloud server (V2N), and the like. An architecture of the V2X communication, including the V2I communication, may adopt an architecture defined in ISO 21217, ETSI TS 102 940-943, IEEE 1609, or the like.

The communication system 43 may transmit and receive a communication signal to and from the internal environment of the vehicle 1, for example, with a mobile terminal 91 such as a smartphone present in the vehicle. A communication device of a terminal communication type in the communication system 43 is, for example, a Bluetooth (registered trademark) device, a Wi-Fi (registered trademark) device, or an infrared communication device. When the mobile terminal 91 of the vehicle user is associated with the vehicle 1 in advance, the communication system 43 may transmit and receive a communication signal to and from the mobile terminal present in the external environment.

The map DB 44 is a database for storing map data usable in the driving system 2. The map DB 44 includes at least one type of non-transitory tangible storage medium of, for example, a semiconductor memory, a magnetic medium, or an optical medium. The map DB 44 may include a database of a navigation unit that navigates a travel route of the vehicle 1 to a destination. The map DB 44 may include a database of a probe data (PD) map generated by using PD collected from each vehicle. The map DB 44 may include a database of a high-definition map having a high level of definition mainly used for an automated driving system. The map DB 44 may include a database of a parking lot map including specific parking lot information, for example, parking space markings information, used for automated parking or parking support.

The map DB 44 appropriate to the driving system 2 acquires and stores the latest map data through, for example, communication with a map server via the communication system 43 of a V2X type. The map data is converted into two-dimensional or three-dimensional data as data indicating the external environment of the vehicle 1. The map data may include, for example, road data representing at least one type among positional coordinates, a shape, and a road surface condition of a road structure and a standard roadway. The map data may include marking data representing at least one type of, for example, a road sign, a road display, and a positional coordinate and a shape of a lane marking attached to a road. The marking data included in the map data may represent, for example, a traffic sign, an arrow marking, a lane marking, a stop line, a direction sign, a landmark beacon, a business sign, or a change in a line pattern of a road among target objects. The map data may include structure data representing at least one type of positional coordinates, a shape, and the like of a building and a traffic light facing the road, for example. The marking data included in the map data may represent, for example, a streetlight, a road edge, a reflecting plate, or a pole among the target objects.

The motion actuator 60 is capable of controlling a vehicle motion based on an input control signal. The motion actuator 60 of a driving type is a power train including, for example, at least one type among an internal combustion engine, a drive motor, and the like. The motion actuator 60 of a braking type is, for example, a brake actuator. The motion actuator 60 of a steering type is, for example, a steering wheel.

Multiple human machine interface (HMI) devices 70 may be mounted on the vehicle 1. The HMI device 70 implements a human machine interaction, which is an interaction between a user of the vehicle 1 and the driving system 2. Some of the multiple HMI devices 70, which implement an operation input functionality for the occupant, may be a part of the sensing unit 10. Some of the multiple HMI devices 70, which implement an information presentation functionality, may be a part of the acting unit 30. Meanwhile, the functionality implemented by the HMI device 70 may be provided as a functionality independent of the sensing functionality, the planning functionality, and the acting functionality.

The HMI device 70 may be an operation input device 70a capable of inputting an operation by the user to transmit the will or intention of the user of the vehicle 1 to the driving system 2. The HMI device 70 of an operation input type, that is, the operation input device 70a, is, for example, an accelerator pedal, a brake pedal, a shift lever, a steering wheel, a turn signal lever, a mechanical switch, and a touch panel of a navigation unit or the like. Among those, the accelerator pedal controls the power train serving as the motion actuator 60. The brake pedal controls the brake actuator serving as the motion actuator 60. The steering wheel controls a steering actuator serving as the motion actuator 60.

The HMI device 70 may be an information presentation device 70b that presents information such as visual information, auditory information, and cutaneous sensory information to the user of the vehicle 1. The HMI device 70 of the visual information presentation type, that is, the information presentation device 70b, is, for example, a meter display 70b1, a navigation unit, a center information display (CID) 70b2, a head-up display (HUD) 70b3, or an illumination unit.

The meter display 70b1 is, for example, a display device disposed in a driver facing portion of an instrument panel facing a driver's seat on which the driver sits. The meter display 70b1 displays information necessary for driving to the driver, focusing on the vehicle state including the velocity of the vehicle 1 and the like. The meter display 70b1 may be a graphic meter that displays all information by an image, or may be a combination meter that combines image display and analog display by a device.

The CID 70b2 is, for example, a display device disposed in a central portion of an instrument panel. The CID 70b2 has the largest display screen among in-vehicle display devices mounted on the instrument panel. The CID 70b2 can display an image not only to the driver but also to the passenger. The CID 70b2 may include a touch panel that can be touch-operated by the vehicle user, and in this case, the CID 70b2 also corresponds to the operation input device 70a.

The HUD 70b3 is a display device disposed on the instrument panel on a side opposite to the meter display 70b1 with the driver's seat being interposed therebetween, that is, on a back side of the driver facing portion. The HUD 70b3 projects an image onto a front windshield of the vehicle 1, thereby enabling the driver to display a virtual image VI that appears to be floating outside the vehicle.

Instead of the CID 70b2 and the meter display 70b1, a pillar-to-pillar display disposed to cross the left and right A-pillars may be adopted. Even in this case, the pillar-to-pillar display may be divided into several screens, each of which may be controlled in the same manner as the CID 70b2 and the meter display 70b1.

The HMI device 70 of an auditory information presentation type is, for example, a speaker and a buzzer. The HMI device 70 of a cutaneous sensory information presentation type is, for example, a vibration unit of the steering wheel, a vibration unit of a driver's seat, a reaction force unit of the steering wheel, a reaction force unit of the accelerator pedal, a reaction force unit of the brake pedal, and an air conditioning unit.

The HMI device 70 may implement an HMI functionality in cooperation with the mobile terminal 91 such as a smartphone by communicating with the terminal through the communication system 43. For example, as an alternative to the information presentation to the HMI device 70, the information of the driving system 2 may be displayed on the screen of the smartphone of the vehicle user through the communication system 43. On the other hand, the HMI device 70 may present information acquired from a smartphone to the user. For example, an operation input to the smartphone may be used as an alternative to an operation input to the HMI device 70.

The HMI device 70 may include, as the operation input device 70a, a feedback device 70a1 that receives feedback of the vehicle user. For example, the feedback device 70a1 includes a computer and a microphone, and when the feedback functionality is selected from the CID 70b2, the voice of the vehicle user is recorded using the microphone for a predetermined time (for example, 45 seconds). Accordingly, the vehicle user can feed back praise, dissatisfaction, or the like to the vehicle 1 or the driving system 2. The feedback device 70a1 may transmit, through the communication system 43, the voice of the vehicle user recorded to an external system present in the external environment. The external system may be the server 96 described below. The vehicle 1 or the driving system 2 can be improved by aggregating the feedback of the vehicle user in the external system.

At least one processing system 50 is provided. For example, the processing system 50 may be an integrative processing system that executes a process related to the sensing functionality, a process related to the planning functionality, and a process related to the acting functionality in an integrated manner. In this case, the integrative processing system 50 may further execute a process related to the HMI device 70, and an HMI dedicated processing system may be separately provided. For example, the HMI dedicated processing system may be an integrated cockpit system that integrally executes a process related to each HMI device 70. The processing system 50 may be provided by an in-vehicle platform that can be generally used for an AV.

For example, the processing system 50 may include each of at least one processing unit corresponding to the process related to the sensing functionality, at least one processing unit corresponding to the process related to the planning functionality, and at least one processing unit corresponding to the process related to the acting functionality.

The processing system 50 includes a communication interface for an outside, and is connected to at least one type of elements related to the process performed by the processing system 50 among each sensor 40, the motion actuator 60, the HMI device 70, and the like via at least one type among, for example, a local area network (LAN), a wire harness, an internal bus, and a wireless communication circuit.

The processing system 50 includes at least one dedicated computer 51. The processing system 50 may combine multiple dedicated computers 51 to implement a functionality such as the sensing functionality, the planning functionality, and the acting functionality.

For example, the dedicated computer 51 forming the processing system 50 may be an integrated ECU that integrates driving functionalities of the vehicle 1. The dedicated computer 51 forming the processing system 50 may be a determination ECU that determines a DDT. The dedicated computer 51 forming the processing system 50 may be a monitoring ECU that monitors driving of the vehicle 1. The dedicated computer 51 forming the processing system 50 may be an evaluation ECU that evaluates driving of the vehicle 1. The dedicated computer 51 forming the processing system 50 may be a navigation ECU that navigates a travel route of the vehicle 1.

The dedicated computer 51 forming the processing system 50 may be a locator ECU that estimates a position of the vehicle 1. The dedicated computer 51 forming the processing system 50 may be an image processing ECU that processes image data detected by the external environment sensor 41. The dedicated computer 51 forming the processing system 50 may be an actuator ECU that controls the motion actuator 60 of the vehicle 1. The dedicated computer 51 forming the processing system 50 may be an HMI control unit (HCU) that integrally controls the HMI devices 70. The dedicated computer 51 constituting the processing system 50 may be, for example, at least one external computer that is provided in an external center or a mobile terminal 91 that enables communication via the communication system 43.

The dedicated computer 51 forming the processing system 50 includes at least one memory 51a and at least one processor 51b. The memory 51a may be, for example, at least one type of non-transitory tangible storage medium, such as a semiconductor memory, a magnetic medium, and an optical medium, which non-temporarily stores a computer program, data, and the like that can be read by the processor 51b. For example, a rewritable volatile storage medium such as a random access memory (RAM) may be provided as the memory 51a. The processor 51b includes, for example, at least one type of a central processing unit (CPU), a graphics processing unit (GPU), and a reduced instruction set computer (RISC)-CPU as a core.

The dedicated computer 51 forming the processing system 50 may be a system on a chip (SoC) in which the memory 51a, the processor 51b, and an interface are integrally implemented on one chip, or at least one SoC may be provided as an element of the dedicated computer 51.

The processing system 50 may include at least one database for executing the DDT. The database may include, for example, a non-transitory tangible storage medium of at least one type of a semiconductor memory, a magnetic medium, and an optical medium, and an interface for accessing the storage medium.

The database may be a scenario database (hereafter, referred to as "scenario DB") 59. The database may be a rule database (hereinafter, rule DB) 58. At least one of the scenario DB 59 and the rule DB 58 may not be provided in the processing system 50, but may be provided independently in the driving system 2. At least one of the scenario DB 59 and the rule DB 58 may be provided in an external system present in an external environment and configured to be accessible from the processing system 50 via the communication system 43.

The scenario DB59 has a scenario catalog in which a plurality of scenarios used for driving the vehicle 1 are stored. The driving system 2 can, for example, apply the situation in which the vehicle 1 is located to one scenario selected from multiple scenarios or a combination of multiple scenarios. The scenario DB 59 may store multiple scenarios including at least one of a functional scenario, a logical scenario, and a concrete scenario. The functional scenario defines a top-level qualitative scenario structure. The logical scenario is a scenario obtained by assigning a quantitative parameter range to a structured functional scenario. The concrete scenario defines a boundary of a safety determination for distinguishing between a safe state and an unsafe state.

The rule DB 58 stores a rule set used for driving the vehicle 1. The rule set may include multiple rules. The rule set may further include a structure of the degree of priority for a series of rules, which is set based on a relative importance among the multiple rules. The rule set may be an implementation of guidelines for strategic driving of the vehicle 1.

The multiple rules may include rules based on laws, regulations, and a combination thereof. The multiple rules may include rules based on a preference that is not influenced by the laws, the regulations, or the like. The multiple rules may include rules based on a motion behavior based on an experience in the past. The multiple rules may include rules based on a characterization of a motion environment. The multiple rules may include rules based on ethical concerns. The multiple rules may include rules based on a basic principle of a safety model (for example, the five principles of an RSS model). The multiple rules may include a traffic rule. The traffic rule may be a rule defined in the Road Traffic Law, or may be a rule based on national or regional customs.

The rules such as the traffic rules stored in the rule DB 58 may be positioned as the information provided from the sensing unit 10 to the planning unit 20 by the sensing functionality, similarly to the map information acquired from the map DB 44.

The processing system 50 may also include at least one recording device 55 that records at least one of the sensing information, planning information, and action information of the driving system 2. The recording device 55 may include at least one large-capacity storage medium 55c. The storage medium 55c may be at least one type of non-transitory tangible storage medium among, for example, a semiconductor memory, a magnetic medium, and an optical medium.

The storage medium 55c may be mounted on a substrate in a form that is not easily detachable or replaceable, and in this form, for example, an embedded Multi Media Card (eMMC) or the like using a flash memory may be adopted. At least one storage medium 55c may be in a form that is detachable and replaceable with respect to the recording device 55, and in this form, for example, an SD card or the like may be adopted.

The recording device 55 may have a functionality of selecting information to be recorded from among the sensing information, the planning information, and the action information. In this case, the recording device 55 may include a dedicated computer.

The dedicated computer provided in the recording device 55 has at least one memory 55a and at least one processor 55b. The memory 55a may be, for example, at least one type of non-transitory tangible storage medium, such as a semiconductor memory, a magnetic medium, and an optical medium, which non-temporarily stores a computer program, data, and the like that can be read by the processor 55b. For example, a rewritable volatile storage medium such as a random access memory (RAM) may be provided as the memory 55a. The processor 55b includes, for example, at least one type of a central processing unit (CPU), a graphics processing unit (GPU), and a reduced instruction set computer (RISC)-CPU as a core.

The dedicated computer may be a system on a chip (SoC) in which the memory 55a, the processor 55b, and an interface are integrally implemented on one chip, or at least one SoC may be provided as an element of the dedicated computer.

The recording device 55 may access the storage medium 55c, and execute recording in accordance with a data write command from each unit of the driving system 2. The recording device 55 may determine information transmitted to the in-vehicle network, access the storage medium 55c, and execute recording based on determination of the processor 55b provided in the recording device 55.

The recording device 55 may not be provided in the processing system 50 but may be provided independently in the driving system 2. The recording device 55 may be provided in the external system present in the external environment, and configured to be accessible from the processing system 50 via the communication system 43.

The processing system 50 may include at least one risk checker 53. The risk checker 53 may be one aspect of on-board implementation of responsibility sensitive safety (RSS) as a safety model. The risk checker 53 may be an on-board checker for the planning functionality implemented by the dedicated computer 51. The risk checker 53 implements, in hardware manner, the risk checking unit 26 that implements the risk checking functionality, independent of the planning unit 20.

The risk checker 53 may be configured mainly with a dedicated computer having at least one memory 53a and at least one processor 53b. The memory 53a may be, for example, at least one type of non-transitory tangible storage medium, such as a semiconductor memory, a magnetic medium, and an optical medium, which non-temporarily stores a computer program, data, and the like that can be read by the processor 53b. For example, a rewritable volatile storage medium such as a random access memory (RAM) may be provided as the memory 53a. The processor 53b includes, for example, at least one type of a central processing unit (CPU), a graphics processing unit (GPU), and a reduced instruction set computer (RISC)-CPU as a core.

The dedicated computer may be a system on a chip (SoC) in which the memory 53a, the processor 53b, and an interface are integrally implemented on one chip, or at least one SoC may be provided as an element of the dedicated computer.

As described above, the processing system 50 includes the memories 51a, 53a, and 55a that store software. The processors 51b, 53b, and 55b are configured to implement automated driving by operating software so that authority transfer can be performed between the system itself and the user. The software here may include the computer program itself used in the driving system 2. The software here may include an algorithm in the computer program used in the driving system 2. The software here may include parameters in the computer program used in the driving system 2. The software here may include AI or a trained model, which is implemented by, for example, a neural network used in the driving system 2. The software may include data stored in a database referred to in the processing system 50, data stored in the map DB 44, and the like. One piece of software may correspond to one application, may correspond to multiple applications, may be a part of one application, or may be software commonly used by multiple applications.

The processing system 50 may include at least one software management unit 57. The software management unit 57 implements a software management functionality.

The software management unit 57 manages various types of software used in the processing system 50, such as the computer 51, the risk checker 53, the recording device 55, the rule DB 58, and the scenario DB 59. The software management unit 57 may further manage software used in the driving system 2 outside the processing system 50. For example, the software management unit 57 may manage data stored in the map DB 44, software used for a drawing process by the information presentation device 70b, software used for a communication process by the communication system 43, and the like.

The software management may include software version management, a download process and installation process, an uninstallation process, and the like. The software management may include a software test.

In order to implement a software management functionality, the software management unit 57 may be mainly configured with a dedicated computer having at least one memory 57a and at least one processor 57b. The memory 57a may be, for example, at least one type of non-transitory tangible storage medium, such as a semiconductor memory, a magnetic medium, and an optical medium, which non-temporarily stores a computer program, data, and the like that can be read by the processor 57b. For example, a rewritable volatile storage medium such as a random access memory (RAM) may be provided as the memory 57a. The processor 57b includes, for example, at least one type of a central processing unit (CPU), a graphics processing unit (GPU), and a reduced instruction set computer (RISC)-CPU as a core.

The dedicated computer may be a system on a chip (SoC) in which the memory 57a, the processor 57b, and an interface are integrally implemented on one chip, or at least one SoC may be provided as an element of the dedicated computer.

The above-described architecture is merely an example, and various configurations can be adopted as the hardware configuration of the driving system 2.

### Logical Architecture in Automated Driving

Next, an example of a logical architecture of the driving system 2 will be described with reference to FIG. 2. The description herein will focus on a process performed by a computer program executed during automated driving at level 3 or higher. The sensing unit 10 may include an environment perception unit 11, a self-position perception unit 12, and an internal perception unit 13 as processing units for implementing, by executing a computer program by the processor 51b, sub-functionalities obtained by further classifying the sensing functionalities.

The environment perception unit 11 individually processes information (referred to as sensor data in some cases) on an external environment acquired from each sensor 40 and implements a functionality of perceiving the external environment including a target object, other road users, and the like. The environment perception unit 11 processes detection data detected by each external environment sensor 41 individually. The detection data may be detection data provided from, for example, a millimeter wave radar, a sonar, or a LiDAR. The environment perception unit 11 may generate relative position data including a direction, a size, and a distance of an object with respect to the vehicle 1, from raw data detected by the external environment sensor 41.

The detection data may be image data provided from, for example, a camera or a LiDAR. The environment perception unit 11 processes the image data, and extracts an object that is reflected in an angle of view of the image. The extraction of the object may include estimation of the direction, the size, and the distance of the object with respect to the vehicle 1. The extraction of the object may include, for example, classification of the object by using semantic segmentation.

The environment perception unit 11 processes information acquired through a V2X functionality of the communication system 43. The environment perception unit 11 processes information acquired from the map DB 44.

The environment perception unit 11 may be further classified into multiple sensor perception units each optimized for one sensor group. The sensor perception unit may fuse information of one sensor group when the sensor perception unit is associated to perceive information of the one sensor group.

The self-position perception unit 12 conducts localization of the vehicle 1. The self-position perception unit 12 acquires global position data of the vehicle 1 from the communication system 43 (for example, the GNSS receiver). In addition, the self-position perception unit 12 may acquire position information on the target object extracted by the environment perception unit 11. The self-position perception unit 12 acquires map information from the map DB 44. The self-position perception unit 12 integrates these pieces of information to estimate a position of the vehicle 1 on a map.

The internal perception unit 13 implements a functionality of perceiving a vehicle state by processing detection data detected by each internal environment sensor 42. The vehicle state may include a state of a motion physical quantity of the vehicle 1 detected by a velocity sensor, an acceleration sensor, a gyro sensor, or the like. The vehicle state may include at least one type of a state of a user, an operation state of the user with respect to the motion actuator 60, and a switching state of the HMI devices 70.

The planning unit 20 may include a prediction unit 21, a driving planning unit 22, and a mode management unit 23 as processing units for implementing, by executing a computer program by the processors 51b and 53b, sub-functionalities obtained by further classifying the planning functionalities.

The prediction unit 21 acquires external environment information perceived by the environment perception unit 11 and the self-position perception unit 12, the vehicle state perceived by the internal perception unit 13, and the like. The prediction unit 21 may interpret an environment based on the acquired information, and estimate the current situation in which the vehicle 1 is located. The situation here may be an operational situation, or may include an operational situation.

The prediction unit 21 may interpret the environment and predict actions of objects such as other road users. The object here may be a safety-relevant object. The prediction of the action here may include at least one of prediction of a velocity of the object, prediction of an acceleration of the object, and prediction of a trajectory of the object. The prediction of the act may be executed based on a reasonably foreseeable assumption. The prediction unit 21 may estimate an intention of the user, based on the predicted action, the predicted potential hazard, and the acquired vehicle state.

The driving planning unit 22 plans automated driving of the vehicle 1, based on at least one type of estimation information of the position of the vehicle 1 on the map provided by the self-position perception unit 12, prediction information and user intention estimation information provided by the prediction unit 21, functional constraint information provided by the mode management unit 23, and the like.

The driving planning unit 22 implements a route planning functionality, a behavior planning functionality, and a trajectory planning functionality. The route planning functionality is a functionality of planning at least one of a route to a destination and a lane plan at a middle distance based on the estimation information of the position of the vehicle 1 on the map. The route planning functionality may further include a functionality of determining at least one request of a lane changing request and a deceleration request, based on the lane plan at the middle distance. The route planning functionality may be a mission/route planning functionality in a strategic function, or may be a functionality of outputting a mission plan and a route plan.

The behavior planning functionality is a functionality of planning a behavior of the vehicle 1, based on at least one of the route to the destination and the lane plan at the middle distance planned by the route planning functionality, the lane changing request and the deceleration request, the prediction information and the user intention estimation information provided by the prediction unit 21, and the functional constraint information provided by the mode management unit 23. The behavior planning functionality may include a functionality of generating a condition related to a state transition of the vehicle 1. The condition related to the state transition of the vehicle 1 may correspond to a triggering condition. The condition related to the state transition may include a fallback condition for executing the DDT fallback.

The behavior planning functionality may include a functionality of determining a state transition of an application that implements a DDT, and further include a functionality of determining a state transition of a driving action, based on the condition. Accordingly, when the driving planning unit 22 plans the execution of the DDT fallback, and this does not involve authority transfer, the driving planning unit 22 may further execute a minimal risk maneuver (MRM) together with a motion control unit 31 to shift the vehicle 1 to the minimal risk condition. The planning of the MRM may be implemented by a behavior planning functionality or may be implemented by a trajectory planning functionality.

The behavior planning functionality may include a functionality of determining a constraint related to a path of the vehicle 1 in a longitudinal direction and a constraint related to the path of the vehicle 1 in a lateral direction, based on information on these state transitions. The behavior planning functionality may be strategic behavior planning in a DDT functionality, or may output a strategic behavior.

The trajectory planning functionality is a functionality of planning a travel trajectory of the vehicle 1, based on the determination information provided by the prediction unit 21, the constraint related to the path of the vehicle 1 in the longitudinal direction, and the constraint related to the path of the vehicle 1 in the lateral direction. The trajectory planning functionality may include a functionality of generating a path plan. The path plan may include a velocity plan, or the velocity plan may be generated as a plan independent of the path plan. The trajectory planning functionality may include a functionality of generating multiple path plans and selecting an optimal path plan from the multiple path plans, or a functionality of switching between the path plans. The trajectory planning functionality may further include a functionality of generating backup data of the generated path plan. The trajectory planning functionality may be a trajectory planning functionality in the DDT functionality, or may output a trajectory plan.

The mode management unit 23 monitors the driving system 2, and sets a constraint on a functionality related to driving. The mode management unit 23 may manage a mode of automated driving, for example, a state of the automation level. The management of the automation level may include switching between manual driving and automated driving, that is, authority transfer between the user and the driving system 2, that is, management of takeover of driving. The mode management unit 23 may monitor a state of a subsystem related to the driving system 2, and determine a defect of the system (for example, an error, an unstable operation state, a system failure, or a failure). The mode management unit 23 may determine a mode based on the intention of the user, based on the user intention estimation information generated by the internal perception unit 13. The mode management unit 23 may set a constraint on a functionality related to driving, based on at least one of a determination result of the defect of the system, a determination result of the mode, and further, the vehicle state provided by the internal perception unit 13, a sensor abnormality (or sensor failure) signal output from the sensor 40, state transition information of the application and the trajectory plan provided by the driving planning unit 22, and the like.

The mode management unit 23 may have a functionality of determining the constraint related to the path of the vehicle 1 in the longitudinal direction and the constraint related to the path of the vehicle 1 in the lateral direction in an integrated manner, in addition to the functional constraint related to driving. In this case, the driving planning unit 22 plans a behavior and plans a trajectory, in accordance with the constraint determined by the mode management unit 23.

When the risk checking functionality is implemented as a part of the planning unit 20, the risk checking functionality may be implemented as a part of the functionalities implemented by the prediction unit 21, the driving planning unit 22, and the mode management unit 23.

The risk checking functionality is a functionality of acquiring an environment model, sensor data, and the like from the sensing unit 10, evaluating a risk according to these pieces of information, and outputting a response according to the risk to the acting unit 30 or the driving planning unit 22. This series of functionalities or processes may be referred to as risk checking or risk monitoring.

More specifically, with the risk checking functionality, the situation is output based on the information acquired from the sensing unit 10. With the risk checking functionality, whether this situation is a safe situation or a hazardous situation is checked. The checking may include checking of an estimated result of a collision risk between the vehicle 1 and the surrounding object. In this checking, an index such as a collision probability can be used in consideration of uncertainty. The risk checking functionality may determine whether there is a hazardous situation by comparing an acceptable threshold of the collision risk with the estimated value of the collision risk. The threshold of the acceptable threshold of the collision risk may be set in advance based on risk acceptance criteria/criterion described in detail below.

The risk checking functionality derives a proper response based on the checking result. The proper response may be provided to the acting unit 30 or the driving planning unit 22 only when the situation is determined to be a hazardous situation. The proper response may be a restriction of a control command of the motion actuator 60. The proper response may be a response to return the vehicle 1 to a safe state.

The risk checking functionality is implemented by implementing a safety model. The safety model may be referred to as a safety-related model. The safety model may be a formal model. As the safety model, for example, the RSS model may be adopted. Meanwhile, another model such as an SFF model, a more generalized model, or a composite model obtained by combining multiple models may also be adopted. The SFF is a safety force field.

In the RSS model, for example, a safe distance in a longitudinal direction and a safe distance in a lateral direction with respect to other road users are used as indexes used for checking the collision risk. The safe distance is an example of a geometric approach such as a safety envelope.

The acting unit 30 may include a motion control unit 31 and an HMI output unit 71 as processing units for implementing, by executing a computer program by the processor, sub-functionalities obtained by further classifying the action functionalities. The motion control unit 31 controls a motion of the vehicle 1, based on the trajectory plan (for example, the path plan and the velocity plan) acquired from the driving planning unit 22. Specifically, the motion control unit 31 generates accelerator request information, shift request information, brake request information, and steering request information corresponding to the trajectory plan, and outputs the accelerator request information, the shift request information, the brake request information, and the steering request information to the motion actuator 60.

The motion control unit 31 is capable of directly acquiring the vehicle state perceived by the sensing unit 10 (particularly, the internal perception unit 13), for example, at least one of a current velocity, a current acceleration, and a current yaw rate of the vehicle 1 from the sensing unit 10, and reflecting the vehicle state on the motion control of the vehicle 1.

The HMI output unit 71 outputs information on an HMI, based on at least one of the prediction information and the user intention estimation information provided by the prediction unit 21, the state transition information of the application and the trajectory plan provided by the driving planning unit 22, the functional constraint information provided by the mode management unit 23, and the like. The HMI output unit 71 may manage a vehicle interaction. The HMI output unit 71 may generate a notification request based on a management state of the vehicle interaction, and control an information presentation functionality of the HMI devices 70. The HMI output unit 71 may generate a control request for a wiper, a sensor cleaning device, a headlight, and an air conditioner based on the management state of the vehicle interaction, and control these devices.

### V&V of Driving System

It is required to execute a verification and validation (V&V) process on the driving system 2 described above. The V&V here may be V&V for a functionality intended by the software used in the driving system 2 or V&V for SOTIF. A scenario that the vehicle 1 may encounter can be classified into a known hazardous scenario, a known non-hazardous scenario, an unknown hazardous scenario, and an unknown non-hazardous scenario. The V&V process may be a process that reduces risks of a known hazardous scenario and an unknown hazardous scenario among these scenarios.

In the V&V of the driving system 2, there are verification for satisfying a safety requirement of each technical level and verification for safe integration of elements. The verification for satisfying the safety requirement of each technical level may include evaluation of at least one of the following functionalities and abilities, preferably all of the functionalities and abilities. The verification may include evaluation of other functionalities and capabilities.

For example, an evaluation target for the sensing unit 10 is a functionality of the sensor 40 or an external data source (for example, a map data source), a functionality of a sensor algorithm that models an environment, and reliability of the infrastructure and the communication system 43.

For example, the evaluation target related to the planning unit 20 is the capability of the decision algorithm. The capability of the determination algorithm is, for example, a capability of safely handling a potential lack of functionality, and a capability of making a proper determination according to an environment model, a driving policy, a current destination, and the like. For example, the evaluation targets related to the planning unit 20 include one of the absence of unreasonable risks due to hazardous behaviors of the intended functionality, the functionality of the system to safely handle ODD use cases, a robust capability of execution of the entire ODD driving policy, suitability for DDT fallback, and suitability for minimal risk conditions.

For example, the evaluation target may include not only the nominal capability of the system or the functionality but also the robust capability. The robust capability of the system or the functionality is a robust capability of a system under adverse environmental conditions affected by various disturbances, suitability of a system operation under known triggering conditions, sensitivity of an intended functionality, an ability to monitor various scenarios, or the like.

The V&V may be executed with a goal of achieving a positive risk balance by the automated driving executed by the driving system 2. It can be said that the positive risk balance is a main measure of a logically acceptable risk level.

More specifically, the V&V may be executed with a goal of achieving risk acceptance criteria/criterion that can be set based on the positive risk balance. The quantitative criterion of the risk acceptance criteria/criterion is, for example, a probability of occurrence of harm falling below a threshold. The risk acceptance criteria/criterion may be set by, for example, a combination of a statistical approach such as traffic accidents and an approach based on a scenario.

When software related to at least one of a behavior plan and a trajectory plan by the driving planning unit 22 is verified or tested, it is necessary to confirm that the driving system 2 performs at least a safer behavior than a competent and careful driver or an experienced and attentive driver. When software is tested in a virtual environment, for example, a verification method based on a software-in-the-loop (SiL) may be conducted using a reference data set including a scenario stored in a scenario DB.

When software related to mode management by the mode management unit 23 is verified or tested, in particular, the verification or test related to the determination of the ODD and the management of an operating state and a non-operating state may be conducted by SiL, may be conducted by a hardware-in-the-loop (HiL), or may be conducted by both.

When the software related to the HMI by the HMI output unit 71 or the like is verified or tested, the verification or test may be conducted by the HiL and a driver-in-the-loop (DiL). The test with the DiL may be performed on a vehicle user who does not have previous experience or knowledge about the driving system 2 and is unfamiliar with automated driving.

As described above, in the verification or test of the software in the driving system 2, a verification method such as the SiL, the HiL, and the DiL may be selected according to the target and purpose of the verification or test. The loop used for the SiL, the HiL, and the DiL may be an opened loop or a closed loop.

### Test after Shipping to Market

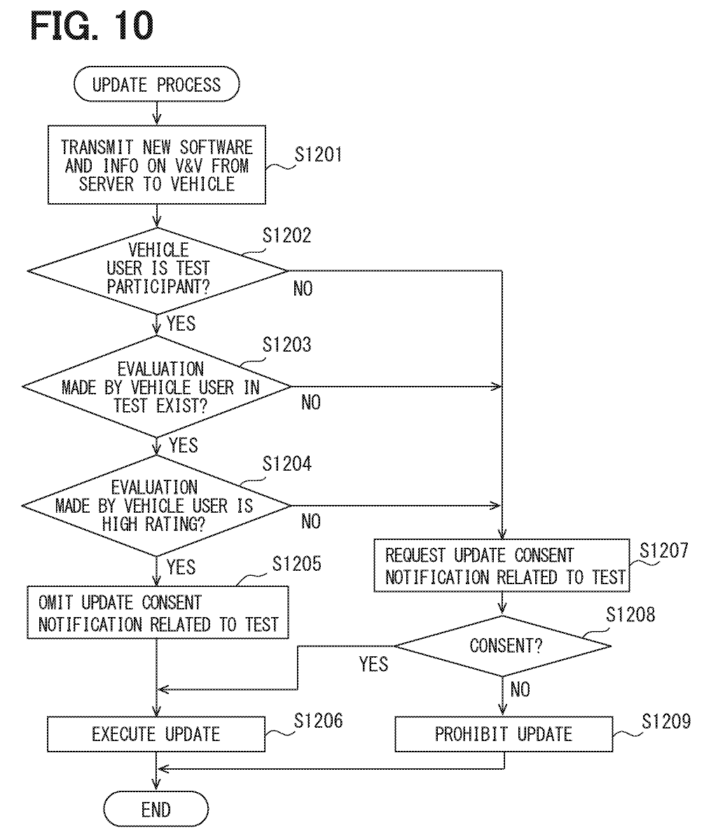

In order to manage an unacceptable risk and improve the driving system 2, it is preferable that there is a strong management system MS for the driving system 2 after shipment to the market. For example, a management system MS illustrated in FIG. 10 changes the software for a vehicle population by over-the-air (OTA). The management system MS includes the vehicle population including multiple vehicles TTA and TTB, and the server 96. The vehicles TTA and TTB managed by the management system MS may have the same configuration as the vehicle 1 including the driving system 2 described above, and some of the hardware specifications such as the vehicle type and the vehicle model may be different from each other as long as there is compatibility in the software specifications at least.

In the test in the change process, data collected while each of the vehicles TTA and TTB belonging to the vehicle population is traveling on an open road may be used. In the test in the change process, an index related to safety may be used. The result of the validation using the index related to safety may not be used only to determine whether the test software is applicable. For example, the result may be used to set the ODD itself or to set parameter restrictions by the ODD. In the following description, software used for a temporary test may be referred to as test software, and software used formally (permanently) may be referred to as formal software.

The index related to safety may be a value obtained by indexing the risk checked by the risk checking unit 26. The value obtained by indexing the risk includes, for example, the risk value, the safety envelope, the safety distance, and the violation metric (violation degree) described above. The violation metric (violation degree) is a value obtained by evaluating the degree of violation of the vehicle 1 (test target vehicle) with respect to the rule stored in the rule set.

The index related to safety may be a safety metric of the automated driving system. The safety metric may mean a scale that can be quantified based on collision rates. Examples of the safety metric include the severity and frequency of collision, the severity and frequency of citable offences, the distances in the longitudinal direction and the lateral direction, the accelerations in the longitudinal direction and the lateral direction, the jerk in the longitudinal direction and the lateral direction, the OEDR response time, and the like. The severity of the collision may be evaluated in six stages using, for example, an abbreviated injury scale (AIS). The distances in the longitudinal direction and the lateral direction are indexes related to maintenance of a safety envelope or a safety distance.

The evaluation of an index or the like related to safety may be a human evaluation. The human here may be a vehicle user of a test target vehicle. The human here may be a vehicle user unfamiliar with automated driving. In the test with the DiL, the evaluation index may be an evaluation input by a driver who is a vehicle user through the operation input device 70a (for example, the feedback device 70a1) of the test target vehicle, or may be an evaluation input through the mobile terminal 91 owned by the driver. The human here may be another VRU such as a pedestrian who encounters the test target vehicle. In this case, the evaluation may be an evaluation transmitted to the driving systems 2A and 2B or the server 96 by another VRU who feels that the test target vehicle is hazardous using the mobile terminal 91 or the like owned by the VRU.

The management system MS executes, using the vehicle population, a test of software that can be used in the driving systems 2A and 2B. The management system MS applies the software whose validity is checked by the test to the driving systems 2 in the vehicle population. Accordingly, the management system MS is an improvement system that improves convenience and safety of the vehicles TTA and TTB belonging to the vehicle population.

### Configuration Example of Server

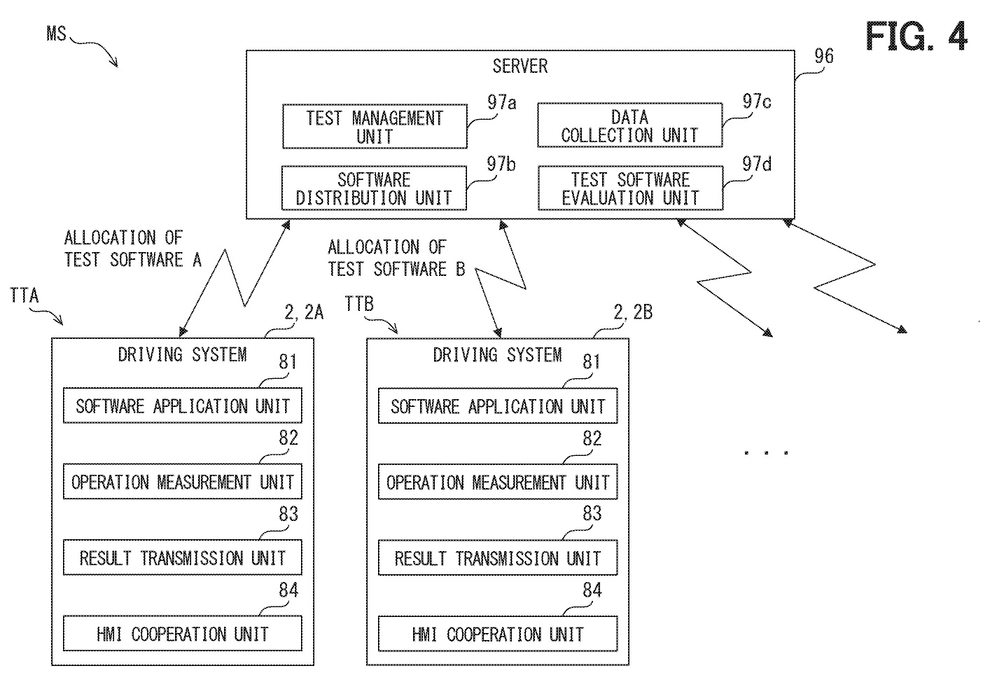

As shown in FIG. 4, the server 96 is installed in an external environment for the vehicles TTA and TTB. The server 96 is communicably connected to the vehicles TTA and TTB by, for example, V2X communication via a communication infrastructure. The server 96 may be connected to, for example, an operation terminal operated by a human operator, and may form a remote management center that manages the vehicle population together with the operation terminal.

As illustrated in FIG. 1, the server 96 may be mainly implemented by a dedicated computer including at least one memory 96a and at least one processor 96b. The memory 96a may be, for example, at least one type of non-transitory tangible storage medium, such as a semiconductor memory, a magnetic medium, and an optical medium, which non-temporarily stores a computer program, data, and the like that can be read by the processor 96b. For example, a rewritable volatile storage medium such as a random access memory (RAM) may be provided as the memory 96a. The processor 96b includes, for example, at least one type of a central processing unit (CPU), a graphics processing unit (GPU), and a reduced instruction set computer (RISC)-CPU as a core.

The dedicated computer may be a system on a chip (SoC) in which the memory 96a, the processor 96b, and an interface are integrally implemented on one chip, or at least one SoC may be provided as an element of the dedicated computer.

The server 96 may further include a management database (hereafter, the management DB) 96c. The management DB 96c may store information for specifying the vehicles TTA and TTB to be managed by the management system MS. The management DB 96c may store information on specifications of the vehicles TTA and TTB. The management DB 96c may store various types of information collected from the vehicles TTA and TTB. The various types of information may include information for executing an evaluation in a test to be described below.

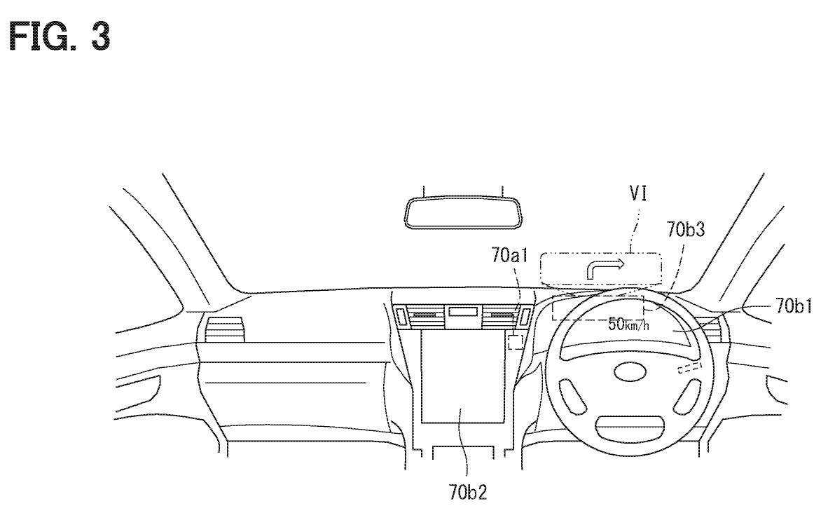

The server 96 implements a software improvement functionality based on the V&V process preferable for the driving system. As illustrated in FIG. 3, the server 96 may include a test management unit 97a, a software distribution unit 97b, a data collection unit 97c, and a test software evaluation unit 97d as processing units for implementing the improvement functionality by the processor 96b executing a computer program.

The test management unit 97a manages a test using the vehicle population. One type of test software may be prepared as an improved version of software being applied to the vehicle population, and the test may be conducted. When two types of test software are prepared and the two types of test software are compared with each other, this test is referred to as an AB test. The multiple pieces of test software may be three or more types of software that have similar functionalities and can be compared with one another.

In the following, as a typical example of the AB test, an example in which one of multiple pieces of test software is allocated to one test target vehicle will be mainly described. On the other hand, various methods can be adopted as a test method, and for example, the AB test can be conducted by allocating multiple pieces of test software to one test target vehicle.

The test software is provided by, for example, a human administrator (hereafter, a test administrator) of the server 96. In this case, the test is conducted for the purpose of selecting the optimum software from the software as a release candidate. On the other hand, when the test is conducted to optimize the parameters used for the computer program, the test software may be software automatically generated by the test management unit 97a in a form of changing the parameters of the existing program.

The test management unit 97a manages the scale of the test and the period of the test. The scale and the period may be set to values input to the server 96 by the test administrator, or may be automatically set by the test management unit 97a. The test management unit 97a determines a test target vehicle suitable for conducting the test from the vehicles TTA and TTB belonging to the vehicle population based on the scale and the period. When the number of vehicles incorporated in the management system MS is smaller than the optimum scale for conducting the test, all the vehicles TTA and TTB belonging to the vehicle population may be designated as the test target vehicles.

The test management unit 97a allocates one of the multiple pieces of test software to the test target vehicle among the vehicles TTA and TTB belonging to the vehicle population. In the AB test for comparing test software A and test software B, for example, half of the test target vehicles test the test software A, and the remaining half of the vehicles test the test software B. The test management unit 97a may randomly allocate the test software to the vehicles TTA and TTB using a pseudo-random number. The test management unit 97a may refer to vehicle information stored in the management DB 96c and execute the allocation of the test software so as to reduce the bias of the condition between the groups for testing the test software.

The test management unit 97a sets at least one evaluation index for evaluating the test software. The evaluation index may be set, based on the functionalities and properties of the test software or the intention of the test, to an index determined by the input operation of the test administrator to the server 96. Alternatively, the evaluation index may be set by the test management unit 97a based on the functionalities and properties of the test software. The evaluation index may include an index related to safety.

The test management unit 97a may manage at least one of a method of acquiring consent of the vehicle user for applying the test software in each test target vehicle and consent content. The test management unit 97a may leave at least one of the consent acquisition method and the consent content entirely to the driving systems 2A and 2B of the test target vehicles.

The software distribution unit 97b distributes the test software to the driving system 2 of the test target vehicle based on the allocation of the test software set by the test management unit 97a. Information on the planning of the test may be distributed together with the distribution of the test software. The information on the planning of the test includes information on a period and an evaluation index of the test, and may further include information such as a scale of the test. Accordingly, the test software distributed by each of the driving systems 2A and 2B is temporarily applied, and the test is started.

The data collection unit 97c collects information on an operation of the test software or an operation result thereof as probe data from each of the driving systems 2A and 2B to which the test software is temporarily applied. The information to be collected may include at least one of an index itself related to safety and information for deriving the index related to safety. The data collection unit 97c accumulates the data sequentially collected from the vehicles TTA and TTB in the management DB 96c.

The test software evaluation unit 97d compares multiple pieces of test software. The test software evaluation unit 97d compares the evaluation indexes, which are set by the test management unit 97a, between pieces of test software. When there are multiple evaluation indexes, the test software evaluation unit 97d compares each of evaluation indexes between pieces of test software.

Specifically, the test software evaluation unit 97d statistically processes the data from the vehicles TTA and TTB accumulated in the management DB 96c. For example, when the evaluation index can be expressed by a ratio such as an occurrence rate, the test software evaluation unit 97d calculates an occurrence rate per vehicle and/or per unit time from the occurrence frequency in the data from the vehicles TTA and TTB.

In the evaluation using the safety metric as the evaluation index, it is preferable to consider severity potential. In the case of evaluating the severity and frequency of a collision for the test software, even if the test software is temporarily applied to multiple vehicles TTA and TTB, it is difficult to statistically evaluate the severity and frequency of a collision when there are few cases in which a collision actually occurs. Therefore, the test software evaluation unit 97d may estimate a rate of serious collisions having a high severity from the occurrence rate of proper precursor events such as a near collision and a collision with a low severity.

The distribution and sensitivity of the collision type may be different between an automated driving system and a human driver. Therefore, in the statistical evaluation of the safety metric for the test software, the evaluation may be performed after the vehicles to which the test software is applied are classified into an automated driving vehicle of level 3 or higher and a vehicle driven by a human user.

The test software evaluation unit 97d may have a functionality of selecting one piece of optimum test software from multiple pieces of test software. The optimum test software may be test software with the highest safety. The test management unit 97a may determine the test software selected by the test software evaluation unit 97d as formal software to be formally adopted.

When the multiple pieces of test software are an improvement plan of a currently applied software that is formally applied to each of the vehicles TTA and TTB, the test software evaluation unit 97d may execute a relative evaluation of the selected test software with respect to the currently applied software. The test software evaluation unit 97d may determine that the selected test software does not have higher capability than the currently applied software. In this case, the test management unit 97a may exclude all of the multiple pieces of test software from formal software to be formally adopted.

On the other hand, the test software evaluation unit 97d may not have a functionality of selecting the optimum test software. In this case, the test management unit 97a presents a comparison result of an evaluation index to the test administrator through the HMI of the server 96, and receives an input operation of the selection result of the formal software to be formally adopted by the test administrator. In accordance with this input operation, the test management unit 97a determines the formal software.

The test software evaluation unit 97d or the test management unit 97a may have an information generation functionality of generating information on V&V of the formal software based on the evaluation result. The information on V&V may be information indicating the validity of the formal software. The information on V&V may be information indicating the safety of the formal software. The safety here may be SOTIF. The information on V&V may be generated in a form suitable for provision to the vehicle user so that the vehicle user can easily understand the information.

For example, the information on V&V may include at least one of information on a V&V process and information on a result based on the process. The information on the V&V process may include information on a test of software. The information on the test of the software may include at least one of information indicating a process of the test and information indicating validity of the process of the test. The information indicating the process of the test may include, for example, at least one of information indicating the type of the test, information indicating a verification method, information indicating an evaluation method, information indicating content of the test software, information indicating a test target vehicle, and information indicating consideration for privacy in the test.

The type of test may be a test in simulation, a test on open roads, or the like. In the case of a test on an open road, whether the test is a test on a test vehicle or a test on a vehicle shipped to the market, such as POV or MaaS, may be further indicated. The verification method may be a test for comparing existing software with test software, an AB test for comparing multiple pieces of test software, or the like. The verification method may be a verification method such as SiL, HiL, or DiL. The verification method may indicate a period of a test, a scale of the test, and the like. The evaluation method may be an evaluation index, an evaluation criterion, or the like for evaluating the test software.

The information indicating the content of the test software may be information indicating a functionality (for example, an ADS functionality) of the test software, information indicating a difference from the formal software, or the like. The information indicating the test target vehicle may be information indicating a selection criterion of the test target vehicle, specifications of the test target vehicle, and the like. The information indicating consideration for privacy in the test may be information indicating that the privacy of the test target vehicle, the privacy of the information perceived by the test target vehicle, and the like are protected.

The information indicating the validity of the process of the test may be information indicating that at least one of the process of the test and a method for determining the process conforms to a standard such as ISO 21448. The information indicating the validity of the process of the test may be information indicating that at least one of the process of the test and a method for determining the process is authenticated by an authentication institution or the like that authenticates safety of an automated driving system or the like.

The information on the result may be information indicating an evaluation result of the test software. The evaluation result may include, for example, a comparison result of the test software with existing software and a comparison result of the test software with another piece of test software. The evaluation result may be an objective numerical value.

The software distribution unit 97b may distribute the formal software to each of the vehicles TTA and TTB belonging to the vehicle population based on the determination of the formal software. The distribution destination vehicle may include a vehicle that belongs to the vehicle population and is not the test target vehicle. The software distribution unit 97b may distribute information on V&V of the software together with the formal software.

The software distribution unit 97b may request another management system to adopt the selected software or recommend the selected software to the other management system. Also in this case, the software distribution unit 97b may present the information on V&V of the software to another management system together with the selected software.

### Configuration Example of Driving System

The vehicles TTA and TTB belonging to the vehicle population are equipped with individual driving systems 2A and 2B, respectively. The driving systems 2A and 2B implement a software management functionality in addition to the perception functionality, the planning functionality, and the acting functionality. The driving systems 2A and 2B may each include a software application unit 81, an operation measurement unit 82, a result transmission unit 83, and an HMI cooperation unit 84 as processing units for implementing functionalities by the processor 57b of the software management unit 57 executing a computer program.

The software application unit 81 manages application of software implemented in the driving systems 2A and 2B. The application of the software here may include download and installation of the software, that is, standby-ready for making the software usable. The management of the application of the software may include defense against external attacks that exploit security vulnerabilities and management of software updates. The update management may include version management of software.

When the update information is acquired from the server 96 and the formal software is distributed from the server 96, the software application unit 81 permanently applies the formal software to the driving systems 2A and 2B. The permanent application here means application until the next update of the formal software. The software application unit 81 may acquire information on V&V of the formal software together with the update information.

The management of the application of software may include management of the application of test software. When the vehicles TTA and TTB are selected as the test target vehicles, the software application unit 81 temporarily applies the test software distributed from the server 96 to the driving systems 2A and 2B, and starts verification of the test software.

The management of the application of software may include the management of consent of a human user to the application of software. The consent can be rephrased as acceptance, permission, contract, or the like. The consent to applying the software may include consent to actually testing the test software (hereinafter, test consent). The consent to the application of software may include consent to update of formal software (hereinafter referred to as update consent). The software application unit 81 requests the consent of the vehicle user based on a consent acquisition method designated in advance by the server 96 or a consent acquisition method set by itself.

When the test consent has been acquired, the software application unit 81 records information indicating the acquisition of the test consent in the storage medium 55c and permits the installation and execution of the test software. When the test consent has not been acquired, the software application unit 81 prohibits installation and execution of the test software.

The software application unit 81 may stop or end the application of the test software to the driving systems 2A and 2B after starting the test. For example, when the test period is completed, the application of the test software is ended. For example, even during the test period, when the formal software to be formally adopted is determined, the application of the test software is ended. For example, when the test itself is stopped due to a serious problem of the test software, the application of the test software is stopped.

When the formal software is to be distributed, the software application unit 81 may attempt to acquire update consent through the HMI cooperation unit 84. When the update consent has been acquired, the software application unit 81 records the information indicating the acquisition of the update consent in the storage medium 55c and permits the installation and execution of the formal software. When the update consent has not been acquired, the software application unit 81 prohibits the installation and execution of the formal software.

The operation measurement unit 82 measures an operation result of the temporarily applied test software. The measurement target is at least one of an evaluation index designated from the server 96 side and data necessary for calculation of the evaluation index. The measurement of the operation result may be constantly conducted according to the properties of the evaluation index, or may be conducted only in a predetermined case based on a preset trigger.

The result transmission unit 83 transmits results of a test to the server 96. The results of the test may be sequentially transmitted in the progress of the test, or may be collectively transmitted at the end of the test period. The results of the test include at least one of test software application information to the driving systems 2A and 2B by the software application unit 81 and measurement information measured by the operation measurement unit 82. The test software application information may include a date and time and a period when the test software is applied to the driving systems 2A and 2B, a method of applying the test software to the driving systems 2A and 2B, and the like. The measurement information is information on the measurement target described above.

One of the operation measurement unit 82 and the result transmission unit 83 may record the results of the test in the storage medium 55c. A transmission log to the server 96 may be recorded in the storage medium 55c together with the results of the test.

As described above, the operation measurement unit 82 selects an index or data to be measured and an acquisition source from which the index or data is acquired, that is, a measurement target, based on the information of the evaluation index received from the server 96. Then, the operation measurement unit 82 generates the measured index or data in the form of measurement information according to a preset format. This format may be designated from the server 96 in the information of the evaluation index. The generated measurement information can be transmitted to the server 96 as probe data and recorded in the storage medium 55c as described above.

The HMI cooperation unit 84 cooperates with the HMI device 70 to implement a functionality of acquiring the above-described consent and a functionality of executing presentation of information related to software management.

The HMI cooperation unit 84 may attempt to acquire test consent from the vehicle user (for example, the driver) in accordance with a request from the software application unit 81. Specifically, the HMI cooperation unit 84 uses the information presentation device 70b to issue notification for requesting test consent to the vehicle user (for example, the driver). The HMI cooperation unit 84 receives an operation input to the operation input device 70a by the driver corresponding to the notification, and confirms the driver's intention of consent. The HMI cooperation unit 84 provides the software application unit 81 with the information indicating that the consent has been acquired from the driver. The HMI cooperation unit 84 issues a notification necessary for the conduction of the test, such as at the start, during the execution, or at the end of the test, to the vehicle user.

The HMI cooperation unit 84 may attempt to acquire the update consent from the vehicle user in accordance with a request from the software application unit 81 at the stage of the update to formal software. An update consent acquisition process is the same as a test consent acquisition process.

The HMI cooperation unit 84 may notify the vehicle user of the information on V&V along with the update of the formal software using the HMI device 70. The information on V&V may be information on a test of formal software. In the update of the formal software for which the installation consent is to be acquired, the HMI cooperation unit 84 may issue a notification of the information on V&V together with the notification for requesting the installation consent. In the update of the formal software for which the installation consent is not acquired, the HMI cooperation unit 84 may issue a notification of the information on V&V together with the notification for conducting the installation.

The HMI cooperation unit 84 may notify the vehicle user of the information on V&V acquired from the server 96 as it is. The HMI cooperation unit 84 may select the information on V&V acquired from the server 96, and then notify the vehicle user of the selected information. The HMI cooperation unit 84 may edit the information on V&V acquired from the server 96 into content more suitable for provision to the vehicle user and then notify the vehicle user of the edited content.

When these notifications are conducted by display using, for example, the CID 70b2 in the HMI device 70, it is easy for the vehicle user to perceive the notifications. Therefore, the HMI cooperation unit 84 may edit the information on V&V in an information amount and a display layout corresponding to a display screen size of the CID 70b2, and output a video signal for displaying the information to the CID 70b2. Alternatively, the HMI cooperation unit 84 may edit the information on V&V in an information amount corresponding to the display screen size of CID 70b2 and provide the information to the HMI output unit 71, and the HMI output unit 71 may generate the display layout and the video signal.

### Example of Processing Flow of Test Conduction

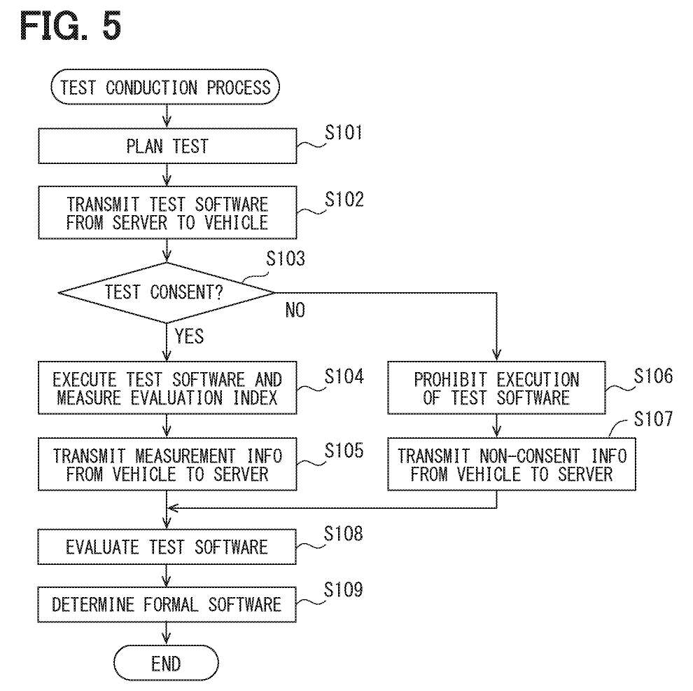

Here, an example of a test conduction method will be described with reference to a flowchart in FIG. 5. In the series of processes, for example, the processor 96b of the server 96 executes a computer program stored in the memory 96a. In response to this, in the driving systems 2A and 2B of the test target vehicles, the processor 57b of the software management unit 57 executes a computer program stored in the memory 57a. In this way, a series of processes is executed. A trigger for starting the process and a trigger for advancing each step may be given by an input operation of the test administrator to a user interface in the server 96.

The flowchart in FIG. 5 illustrates processes from planning a test to evaluation of test software and determination of formal software. In the first S101, a test is planned in the server 96 (for example, the test management unit 97a). The test planning includes at least one, preferably all, of the determination of the scale of the test and the test period described above, the determination of the test target vehicle, the allocation of the test software, an evaluation method of the test software, and a method for acquiring the test consent. After the process in S101, the process proceeds to S102.

In S102, the server 96 (for example, the software distribution unit 97b) transmits the test software to each test target vehicle based on the allocation of the test software in the test target vehicle. In response to this, the driving systems 2A and 2B plan to conduct the test. After the process in S102, the process proceeds to S103.

In S103, in the driving systems 2A and 2B (for example, the software application unit 81 and the HMI cooperation unit 84) of the respective vehicles, the acquisition of the consent of the user is attempted based on a method for acquiring the test consent designated from the server 96 and a method for acquiring the test consent set in advance by the driving systems 2A and 2B. That is, consent is requested. Next, in the driving systems 2A and 2B, the operation of the user on the operation input device 70a or the like is sensed, and it is determined whether the test consent has been acquired. In a test target vehicle with a determination of Yes, the process proceeds to S104. In a test target vehicle with a determination of No, the process proceeds to S106.

In S104, in each of the driving systems 2A and 2B, the test software is executed, and the operation of the test software is measured. That is, the evaluation index designated from the server 96 or data necessary for calculating the evaluation index is measured by the operation measurement unit 82. After the process in S104, the process proceeds to S105.

In S105, each of the driving systems 2A and 2B (for example, the result transmission unit 83) transmits the measurement information obtained by the measurement in S104 to the server 96. In this way, the server 96 collects the measurement information from each test target vehicle in a form that enables a statistical process. After the process in S105, the process proceeds to S108.

On the other hand, in S106 when the test consent has not been acquired, the execution of the test software is prohibited in the driving systems 2A and 2B (for example, the software application unit 81). After the process in S106, the process proceeds to S107. When the test consent has not been obtained, the driving systems 2A and 2B may attempt to acquire the consent again. In this case, the method for acquiring the test consent may be changed in the driving systems 2A and 2B. For example, when the consent operation is an operation unsuitable for the user, the possibility of obtaining the consent of the user can be increased by changing the acquisition method. On the other hand, the method for acquiring the test consent may be maintained as the same method in the driving systems 2A and 2B. When it is determined that the user does not consent intentionally (that is, the consent is denied), the driving systems 2A and 2B may stop acquiring the consent again.

In S107, the driving systems 2A and 2B (for example, the HMI cooperation unit 84) of the test target vehicles from which the consent has not been acquired transmit, to the server 96, information indicating that the consent to the test has not been acquired and a message indicating that the vehicle 1 overlooks participation in the test. After the process in S107, the process proceeds to S108.

In S108, the test software is evaluated in the server 96 (for example, the test software evaluation unit 97d). That is, the evaluation index is compared for each test software. After the process in S108, the process proceeds to S109.

In S109, the formal software is determined in the server 96 (for example, the test management unit 97a) based on the evaluation result in S108. The determination here may be made by autonomous determination by the processor 96b based on the evaluation result, or the formal software may be determined by the processor 96b presenting the evaluation result to the test administrator and receiving the determination operation of the test administrator. The series of processes is ended after S109.

### Example of Update Processing Flow

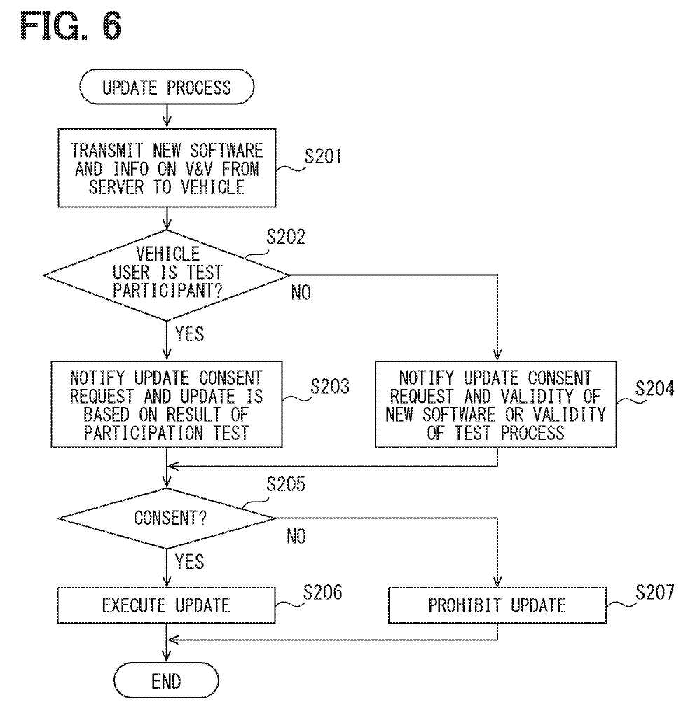

An example of a method of updating the determined formal software (hereinafter, may be referred to as new software) will be described with reference to the flowchart in FIG. 6. In the series of processes, for example, the processor 96b of the server 96 executes a computer program stored in the memory 96a. In response to this, in the driving systems 2A and 2B, the processor 57b of the software management device 57 executes the computer program stored in the memory 57a. In this way, a series of processes is executed. A trigger for starting the process and a trigger for advancing each step may be given by an input operation of the test administrator to a user interface in the server 96.

In the first S201, the server 96 (for example, the software distribution unit 97b) distributes new software to the driving system 2 of each vehicle 1 included in the vehicle population. The server 96 transmits, together with the new software, the information on V&V generated by the server 96 to each of the driving systems 2A and 2B. The distribution destination may include not only a vehicle 1 participating in the test but also a vehicle 1 not participating in the test. After the process in S201, the process proceeds to S202.

In S202, the driving systems 2A and 2B (for example, the software application unit 81) determine whether the vehicle user in the own vehicle 1 is a test participant. If Yes, the process proceeds to S203. If No, the process proceeds to S204.

In S203, the driving systems 2A and 2B (for example, the HMI cooperation unit 84) conduct, using the HMI device 70, a notification to the vehicle user who is the test participant. Here, the notification is a notification of an update consent request to the vehicle user for updating the software being applied to the new software and the information on V&V. The notification of the information on V&V may be a notification that the new software is applied to the vehicle system 1a based on the result of the test in which the vehicle user participates. For example, this notification may be a notification that the update is an update based on the result of the participation test.

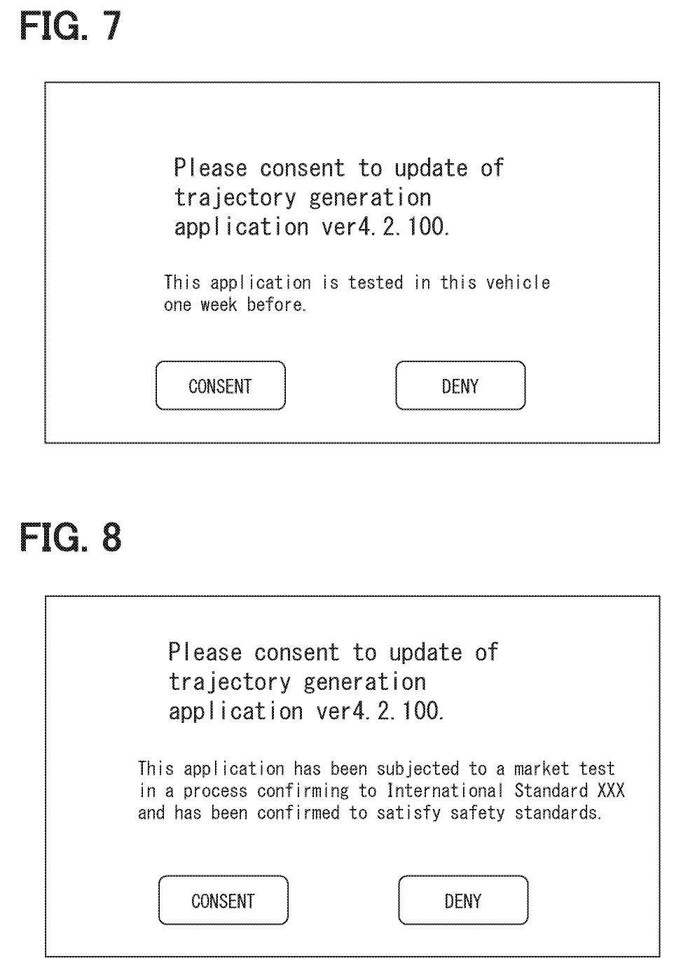

The notification in the S203 may be displayed by, for example, the CID 70b2 as illustrated in FIG. 7. This display includes a display by characters requesting consent to update the application and a display by characters indicating that the application after the update is an application that has conducted a test in the vehicle 1 in the past. A consent switch and a denying switch for presenting an intention of the vehicle user may be displayed in response to the consent request. After the process in S203, the process proceeds to S205.

In S204, the driving systems 2A and 2B (for example, the HMI cooperation unit 84) issue, using the HMI device 70, a notification to the vehicle user who is not the test participant. The notification here is a notification of the update consent request and the information on V&V similarly to the S203, but the notification of the information on V&V is changed to the notification on the premise that the vehicle user is not the test participant. Specifically, the notification of the information on V&V is a notification that the validity of the software is indicated in the test, and that the validity of the process of the test is indicated.

The notification in S204 may be displayed by, for example, the CID 70b2 as illustrated in FIG. 8. This display includes a display by characters requesting consent to update the application, and a display by characters indicating that the updated application has been subjected to a market test such as an AB test or an open road test in a process conforming to the standard and has been confirmed to satisfy the safety standard. A consent switch and a denying switch may be displayed. After the process in S204, the process proceeds to S205.

In S205, the driving systems 2A and 2B (for example, the software application unit 81) determine whether the update consent of the vehicle user has been acquired. If Yes, the process proceeds to S206. If No, the process proceeds to S207.

In S206, the driving systems 2A and 2B (for example, the software application unit 81) execute the update to new software. The series of processes is ended after S206.

In S207, the driving systems 2A and 2B (for example, the software application unit 81) prohibit the update to new software. The series of processes is ended after S207.

Instead of distributing the data of the new software in S201, information indicating that the new software can be distributed may be distributed. In this case, in S206, the server 96 may distribute the new software, and the driving systems 2A and 2B may execute installation of the new software.

In the first embodiment, the software management unit 57 corresponds to an "HMI control device".

According to the first embodiment described above, the vehicle user can acquire the information on V&V of the new software through the HMI devices 70. The vehicle user can perceive the validity of the new software used in the vehicle system 1a through the information on V&V. Therefore, the reliability of the vehicle user to the vehicle system 1a can be enhanced, and the vehicle system 1a can be used at ease.

According to the first embodiment, the notification of the information on the test of the new software is given as the information on V&V. The vehicle user can perceive that the new software is applied through the checking in the test. Therefore, the reliability of the vehicle user in the vehicle system 1a can be further enhanced.

According to the first embodiment, when it cannot be confirmed that the vehicle user is a user participating in the test, the notification of the fact that the validity of the software has been confirmed in the test is given as the information on V&V. Therefore, even when the vehicle user is not directly involved in the test, the reliability in the vehicle system 1a after the new software is applied can be enhanced.

According to the first embodiment, when it cannot be confirmed that the vehicle user is a user participating in the test, the notification of the validity of the process of the test is given as the information on V&V. Therefore, even when the vehicle user is not directly involved in the test, the reliability in the vehicle system 1a after the new software is applied can be enhanced because it is possible to understand that the test is conducted in an appropriate process.

According to the first embodiment, when the vehicle user is the user participating in the test, the notification of the fact that the new software is applied to the vehicle system 1a based on the result of the test in which the vehicle user participates is given as the information on V&V. Therefore, the reliability in the vehicle system 1a after the application of the new software can be enhanced because it can be understood that the vehicle user has directly involved in the test and the new software has been applied.

### Second Embodiment

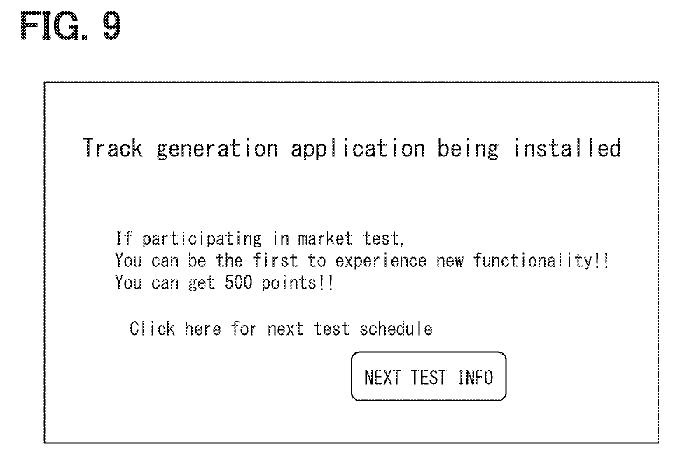

As illustrated in FIG. 9, the second embodiment is a modification of the first embodiment. The second embodiment will be described focusing on differences from the first embodiment.

In the second embodiment, along with the application of the new software in the vehicle system 1a, the vehicle user is notified of at least one of the content of the test and an incentive in the case of participating in the test. Accordingly, the interest of the vehicle user in the test and the perception of the validity of the new software being checked by the test are enhanced.

The notification may be conducted during the update execution process in S206. The expression "during the update execution process" may be "during downloading of the new software" or "during installation of the new software". For example, as illustrated in FIG. 9, this notification may be a display using the CID 70b2. This display may include a display by characters indicating that the application is during the update execution process and a display indicating the content of a specific incentive that can be obtained by the vehicle user when participating in the market test. The content of the specific incentive may be the content of the incentive actually given to the test participant when the market test of the new software during the update execution process is conducted.

When the vehicle user is not a test participant, a notification of information on the next test conduction schedule may be further given. The information on the next test conduction schedule may include at least one of a next test schedule, next test content, a participation method of the next test, and content of an incentive scheduled in the next test.

According to the second embodiment described above, the notification of the incentive obtained by participating in the test is given. When the vehicle user perceives the presence or content of the incentive, the motivation to participate in the next and subsequent tests can be increased. By increasing the number of test participants, the degree of freedom in the scale of the test and the selection of the test target vehicle is increased, and the V&V process with a higher quality can be executed.

### Third Embodiment

As illustrated in FIG. 10, the third embodiment is a modification of the first embodiment. The third embodiment will be described focusing on differences from the first embodiment.

In the update process according to the third embodiment, the acquisition of the update consent is omitted when a specific condition is satisfied. The specific condition may be a condition by which it is determined that there is a low possibility that consent is denied by the vehicle user.

For example, when the test in which the vehicle user participates is a test in which an evaluation by the vehicle user is incorporated, and the evaluation of the test software by the vehicle user is a high rating, the update consent may be omitted. The high rating here may be a case where a rating higher than a median value is obtained in the multi-grade evaluation by the vehicle user. For example, when the evaluation of the first stage or the second stage from the top is obtained in the five-grade evaluation, the update consent may be omitted. The high rating may be, for example, a case where there is no negative message in the feedback to the test software by the vehicle user, and a positive message has been acquired.

An example of an update method will be described with reference to a flowchart in FIG. 10. The first S1201 and 1202 are the same as S201 and S202 in FIG. 6. If Yes in S1202, the process proceeds to S1203. If No in S1202, the process proceeds to S1207.

In S1203, the driving systems 2A and 2B (for example, the software application unit 81) determine whether there is an evaluation of the test software by the vehicle user in the test which has been conducted in the past in response to the new software of this time and in which the vehicle user has participated. If Yes, the process proceeds to S1204. If No, the process proceeds to S1207.

In S1204, the driving systems 2A and 2B (for example, the software application unit 81) determine whether the evaluation by the vehicle user extracted in S1203 is a high rating. For example, in the AB test for comparing the test software A and the test software B, when the test software A is finally adopted, it may be determined whether the evaluation of the test software A by the vehicle user is a high rating. That is, the evaluation of the test software B that is not adopted is not a determination target. When the vehicle user conducts only the evaluation of the test software B, the determination in S1204 may be No. If Yes, the process proceeds to S1205. If No, the process proceeds to S1207.

In S1205, the driving systems 2A and 2B (for example, the software application unit 81) determine that the acquisition of the update consent can be omitted. The driving systems 2A and 2B conduct a notification excluding a notification related to the update consent request among the notifications issued in S203 of FIG. 6. That is, the notification that the new software is applied to the vehicle system 1a is conducted based on the result of the test in which the vehicle user participates. After the process in S1205, the process proceeds to S1206. S1206 is the same as S206 in FIG. 6. If Yes in S1204, the notification in S1205 and the process in S1206 may be conducted at the same time, or S1206 may be first processed after the consent omission determination, and then S1205 may be conducted.

On the other hand, in S1207, the driving systems 2A and 2B (for example, the software application unit 81) determine that the acquisition of the update consent cannot be omitted. That is, the driving systems 2A and 2B conduct the same notification as in S203 or S204 in FIG. 6. After the process in S1207, the process proceeds to S1208. S1208 and S1209 are the same as S205 and S207 in FIG. 6.

According to the third embodiment described above, when software corresponding to test software highly evaluated by the vehicle user is adopted as new software, consent to the application of the new software from the vehicle user is omitted. Accordingly, the complexity felt by the vehicle user can be reduced.

### Fourth Embodiment

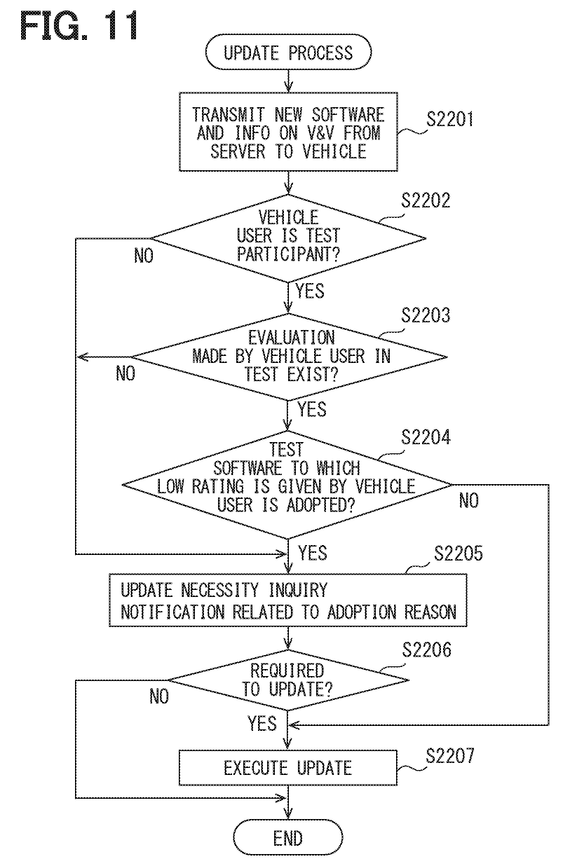

As illustrated in FIG. 11, the fourth embodiment is a modification of the third embodiment. The fourth embodiment will be described focusing on differences from the third embodiment.

In the fourth embodiment, when an update to new software is conducted through a test for comparing multiple pieces of software, for example, an AB test for comparing the test software A and the test software B, a notification for enhancing a sense of satisfaction of the vehicle user for the update is conducted.

For example, in the AB test for comparing the test software A and the test software B, it is assumed that the vehicle user of the vehicle TTA to which the test software A is allocated gives a low evaluation to the test software A using the feedback device 70a1 or the like. The low rating here may mean that the rating was not high. Alternatively, the low rating may be a case where a rating lower than a median value is obtained in the multi-grade evaluation by the vehicle user. The low rating may be, for example, a case where there is no positive message in the feedback to the test software by the vehicle user, and a negative message has been acquired. However, it is assumed that the server 96 adopts the test software A as new software instead of the test software B as a result of the overall evaluation.

For example, in the AB test for comparing the test software A and the test software B, it is assumed that the vehicle user of the vehicle in which both the test software A and the test software B have been tested gives a rating of the test software A which is relatively lower than that of the test software B using the feedback device 70a1 or the like. However, it is assumed that the server 96 adopts the test software A as new software instead of the test software B as a result of the overall evaluation.

In these cases, along with the update to the new software, the driving systems 2A and 2B inquire of the vehicle user whether the update is necessary, and notify the vehicle user of the reason for adopting the adopted new software. The notification regarding the reason for adoption may include at least one of a reason for adopting the test software A and a reason for not adopting the test software B. The notification related to the reason for adoption may be a result (graph or the like) of comparing the evaluation indexes of the test software A and B.

An example of an update method will be described with reference to a flowchart in FIG. 11. S2201 to 2203 are the same as S1201 to 1203 in FIG. 10. However, if No in S2201 and S2203, the process proceeds to S2205.

In S2204 when the determination is Yes in S2203, the driving systems 2A and 2B (for example, the software application unit 81) determine whether the test software to which a low rating is given by the vehicle user in the test is adopted as the new software. If Yes, the process proceeds to S2205. If No, the process proceeds to S2207.

In S2205, the driving systems 2A and 2B (for example, the HMI cooperation unit 84) inquire whether the update is necessary, and conduct a notification related to the reason for adoption. For example, these notifications are displayed in the CID 70b2, and a switch for responding the necessity of update is displayed. After the process in S2205, the process proceeds to S2206.

In S2206, the driving systems 2A and 2B (for example, the software application unit 81) determine whether the update is necessary as a result of the inquiry about the necessity of the update. If Yes, the process proceeds to S2207, and the update is executed as in S2206 of FIG. 10. If No in S2206, the series of processes is ended.

According to the fourth embodiment described above, when the software corresponding to the test software to which a low rating is given by the vehicle user is adopted as the new software, the notification of inquiry of whether the new software needs to be applied to the vehicle system 1a is conducted. The low rating software is restricted from being applied to the vehicle system 1a without the intention of the vehicle user, and therefore, the reliability of the vehicle system 1a can be improved.

According to the fourth embodiment, when the software corresponding to the test software to which a low rating is given by the vehicle user is adopted as the new software, the notification related to the reason for adopting the new software is conducted. When the vehicle user perceives the reason for adoption, the satisfaction of the vehicle user can be enhanced for the adoption of new software different from the evaluation of the vehicle user.

### Fifth Embodiment

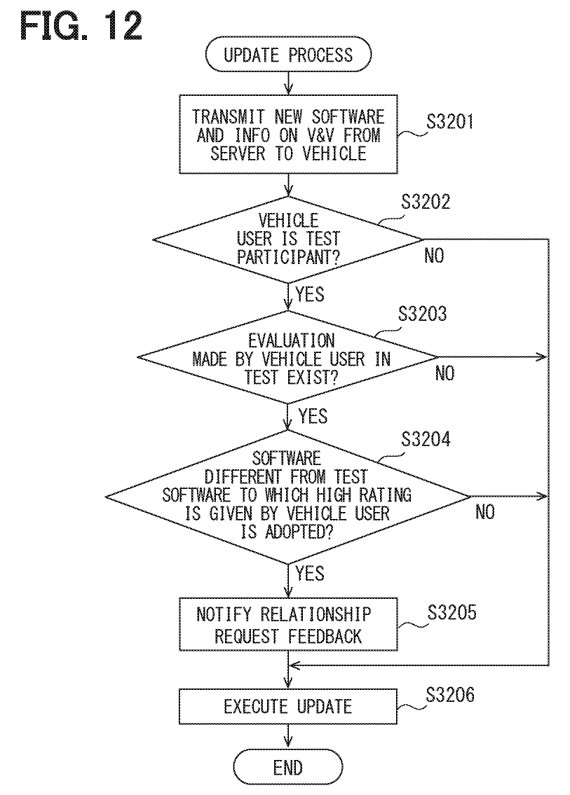

As illustrated in FIG. 12, the fifth embodiment is a modification of the fourth embodiment. The fifth embodiment will be described focusing on differences from the fourth embodiment.

Also in the fifth embodiment, the notification for enhancing the sense of satisfaction of the vehicle user for the update is conducted. For example, in the AB test for comparing the test software A and the test software B, it is assumed that the vehicle user of the vehicle TTA to which the test software A is allocated gives a high rating to the test software A using the feedback device 70a1 or the like. However, it is assumed that the server 96 adopts the test software B as new software instead of the test software A as a result of the overall evaluation.

For example, in the AB test for comparing the test software A and the test software B, it is assumed that the vehicle user of the vehicle in which both the test software A and the test software B have been tested gives a rating of the test software A which is relatively higher than that of the test software B using the feedback device 70a1 or the like. However, it is assumed that the server 96 adopts the test software B as new software instead of the test software A as a result of the overall evaluation.

In these cases, the driving systems 2A and 2B issue, along with the update to the new software, the notification of a relationship between the test software A and the new software to which a high rating is given by the vehicle user, and a feedback request to the vehicle user.

The notification of the relationship between the test software and the new software to which a high rating is given by the vehicle user may include at least one of a notification of matching points between the test software and the new software and a notification of differences between the test software and the new software.

The feedback request to the vehicle user is, for example, prompting the vehicle user to give feedback using the feedback device 70a1. For example, the driving systems 2A and 2B may conduct a notification of requesting feedback using the CID 70b2 or a speaker, and may record a voice of the vehicle user when the vehicle user performs an acceptance operation in the CID 70b2. Accordingly, it is possible to transmit, to the server 96, an opinion or dissatisfaction regarding the fact that the test software to which a high rating is given by the vehicle user was not adopted.

An example of an update method will be described with reference to a flowchart in FIG. 12. S3201 to S3203 are the same as S2201 to S2203 in FIG. 11. However, if No in S2201 and S2203, the process proceeds to S3206.

In S3204 when the determination is Yes in S3203, the driving systems 2A and 2B (for example, the software application unit 81) determine whether software different from the test software to which a high rating is given by the vehicle user in the test is adopted as new software. If Yes, the process proceeds to S3205. If No, the process proceeds to S3206.

In S3205, the driving systems 2A and 2B (for example, the HMI cooperation unit 84) conduct a notification of the relationship between the test software to which a high rating is given by the vehicle user and the new software, and request feedback from the vehicle user. After the process in S2305, the process proceeds to S3206, and the update is executed as in S2206 of FIG. 10. The series of processes is ended after S3206.

According to the fifth embodiment described above, when the software corresponding to the test software to which a high rating is given by the vehicle user is not adopted as the new software, the notification of the relationship between the test software with a high rating and the new software is provided. For example, the reliability in the vehicle system 1a can be increased by causing the vehicle user to perceive that the new software is software having higher validity than the test software.

According to the fifth embodiment, when the software corresponding to the test software to which a high rating is given by the vehicle user is adopted as the new software, the notification of requesting the feedback from the vehicle user is conducted. The dissatisfaction of the vehicle user for the adoption of new software different from the evaluation from the vehicle user can be diverged through feedback.

### Sixth Embodiment

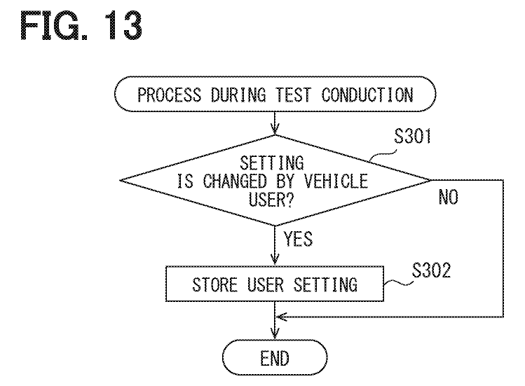

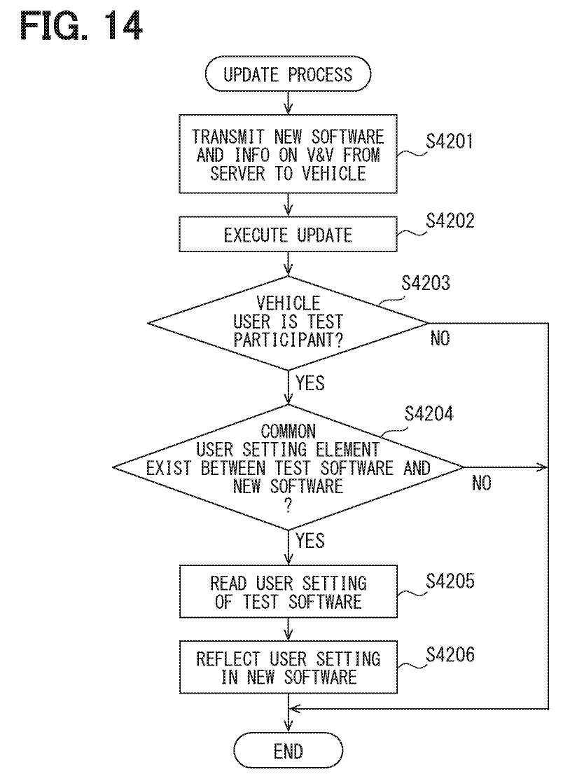

As illustrated in FIGS. 13 and 14, the sixth embodiment is a modification of the first embodiment. The sixth embodiment will be described focusing on differences from the first embodiment.

In the sixth embodiment, when a user setting element is present in the test software, the driving systems 2A and 2B reflect, in the new software, a user setting customized by the vehicle user in the test software during the test.

For example, it is assumed that the test software is software related to a display mode by the information presentation device 70b. In this case, adjustment of luminance, change in display layout, and the like may be present as user setting elements. For example, it is assumed that the test software is software related to a behavior planning functionality of the driving planning unit 22. In this case, the change in the driving mode may be present as the user setting element. The change in the driving mode may be selection of a driving mode such as a ride comfort priority mode, a fuel efficiency priority mode, or a destination arrival time point priority mode. The setting change in the user setting element can be executed, for example, by the vehicle user operating the operation input device 70a.

An example of a processing method related to user settings during conduction of a test will be described with reference to a flowchart in FIG. 13. In the series of processes, the processor 57b of the software management unit 57 executes a computer program stored in the memory 57a in the driving systems 2A and 2B of the test target vehicles.

In the first S301, the driving systems 2A and 2B (for example, the software application unit 81) determine whether a setting change operation of the user setting element is performed by the vehicle user. If Yes, the process proceeds to S302. If No, the series of processes is ended.

In S302, the driving systems 2A and 2B (for example, the software application unit 81) execute a user setting storage process. The user setting data may be stored in a predetermined storage medium provided in the driving systems 2A and 2B, such as the storage medium 55c or the memory 57a. The driving systems 2A and 2B may transmit the user setting data to the server 96 using the communication system 43. The server 96 may store the user setting data in a storage medium such as the management DB 96c or the memory 96a. The series of processes is ended after S302.

Next, an example of an update method will be described with reference to a flowchart in FIG. 14. In the series of processes, for example, the processor 96b of the server 96 executes a computer program stored in the memory 96a. In response to this, in the driving systems 2A and 2B, the processor 57b of the software management device 57 executes the computer program stored in the memory 57a. In this way, a series of processes is executed. A trigger for starting the process and a trigger for advancing each step may be given by an input operation of the test administrator to a user interface in the server 96.

The first S4201 is the same as S201 in FIG. 6. S4202 after the process in S4201 is the same as S206 in FIG. 6. Note that determination in S202, S205, and the like may be executed between S4201 and S4202, and a process similar to S203, S204, and S207 may be executed. After the process in S4202, the process proceeds to S4203. S4203 is the same process as S1202 in FIG. 10. If Yes in S4203, the process proceeds to S4204. If No, the series of processes is ended.

In S4204, the driving systems 2A and 2B (for example, the software application unit 81) determine whether there is a user setting element common to the test software and the new software. If Yes, the process proceeds to S4205. If No, the series of processes is ended.

In S4205, the driving systems 2A and 2B (for example, the software application unit 81) read data related to the common user setting element among pieces of the user setting data from the storage medium in which the user setting data is stored in S302. When the user setting data is stored in the server 96, the data is acquired using the communication system 43. After the process in S4205, the process proceeds to S4206.

In S4206, the driving systems 2A and 2B (for example, the software application unit 81) reflect the data read in S4205 in the user setting of the new software. The series of processes is ended after S4206.

According to the sixth embodiment described above, when the test software and the new software used for the test include the common user setting element, the user setting element set during the test is reflected in the new software along with the application of the new software to the vehicle system 1a. The necessity for the vehicle user to reset the user setting of the new software is restricted, and therefore, the complexity felt by the vehicle user can be reduced.

### Seventh Embodiment

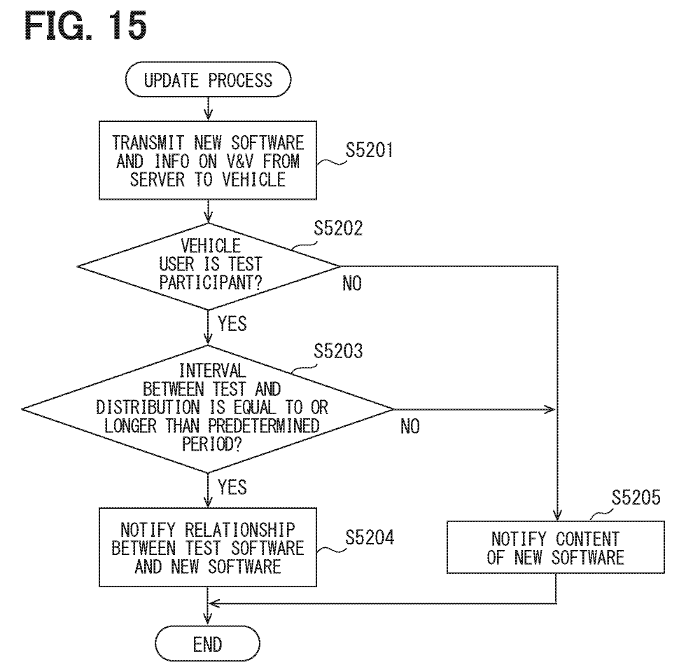

As illustrated in FIG. 15, the seventh embodiment is a modification of the first embodiment. The seventh embodiment will be described focusing on differences from the first embodiment.

In the seventh embodiment, whether to conduct the notification related to V&V is determined according to an interval between a test time and a distribution time of the new software corresponding to the test. When the test time and the distribution time are equal to or longer than the predetermined period, the notification of the information on V&V is conducted. When the test time and the distribution time are shorter than the predetermined period, the notification of the information on V&V is omitted.

The predetermined period refers to a period set in advance as a period in which the vehicle user forgets participating in the test, and is, for example, one month. That is, when the vehicle user forgets participating in the test, it is possible to remind that the vehicle user has participated in the test by being notified of the information on the test.

An example of an update method will be described with reference to a flowchart in FIG. 15. The first S5201 and 5202 are the same as S201 and S202 in FIG. 6. If Yes in S5202, the process proceeds to S5203. If No, the process proceeds to S5205.

In S5203, the driving systems 2A and 2B (for example, the software application unit 81) determine whether the interval between the test time and the distribution time is longer than the predetermined period. If Yes, the process proceeds to S5204. If No, the process proceeds to S5205.

In S5204, the driving systems 2A and 2B (for example, the HMI cooperation unit 84) gives a notification of the relationship between the test software and the new software as information on V&V. The notification of the relationship between the test software and the new software is given, for example, by the display on the CID 70b2. The notification of the relationship between the test software and the new software may be a notification indicating that the new software of this time corresponds to the test software used in the test in which the vehicle user has previously participated. When the new software is partially changed from the test software (for example, bug correction), a notification of the difference may be further given. The series of processes is ended after S5204.

In S5205, the driving systems 2A and 2B (for example, the HMI cooperation unit 84) omit the notification of the information on V&V and give a notification of only content of the new software. The series of processes is ended after S5205.

If No in S5202, notifications of the validity of the new software or the validity of the test process executed in S204 in FIG. 6 may be given without omitting the notification of the information on V&V.

According to the seventh embodiment described above, when the interval between the conduction time of the test and the distribution time of the new software is equal to or longer than the predetermined period, the notification of the relationship between the test software and the new software is given. When the vehicle user is reminded of the conduction of the test, the perception of V&V of the new software can be deepened. Therefore, the reliability of the vehicle user in the vehicle system 1a can be enhanced.

According to the seventh embodiment, when the interval between the conduction time of the test and the distribution time of the new software is shorter than the predetermined period, the notification of the information on V&V is omitted. When the memory of the vehicle user about the conduction of the test is new, the omission can reduce the complexity felt by the vehicle user.

### Eighth Embodiment

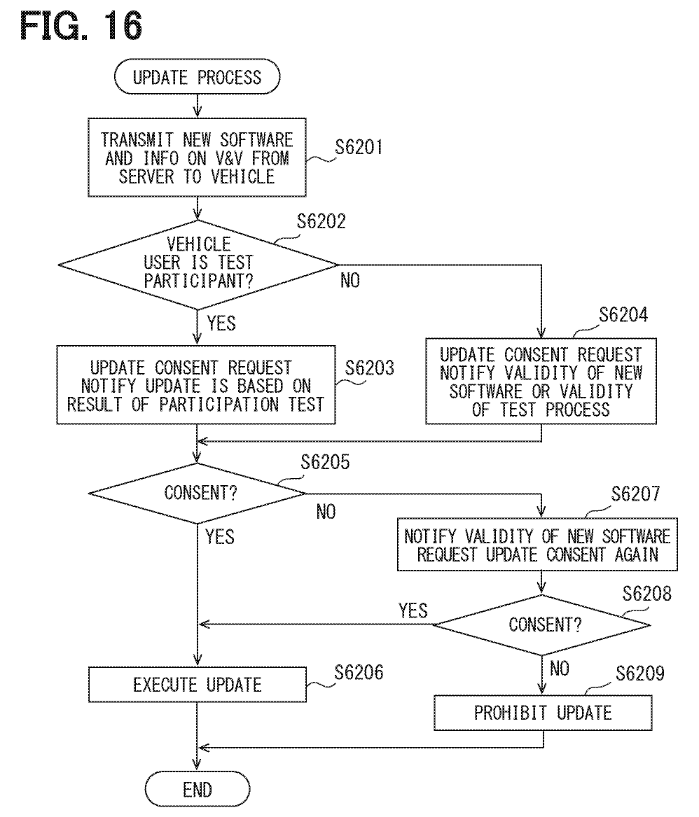

As illustrated in FIG. 16, the eighth embodiment is a modification of the first embodiment. The eighth embodiment will be described focusing on differences from the first embodiment.

In the eighth embodiment, when the update consent is first requested and the update consent has not been acquired, the notification of the information on V&V is given again in more detail, and the update consent is re-requested from the vehicle user.

An example of an update method will be described with reference to a flowchart in FIG. 16. S6201 to 6206 are the same as S201 to 206 in FIG. 6. If No in S6205, the process proceeds to S6207.

In S6027, the driving systems 2A and 2B (for example, the HMI cooperation unit 84) gives a notification of more detailed information on V&V again. Then, the driving systems 2A and 2B (for example, the HMI cooperation unit 84) conduct a notification of re-requesting the update consent from the vehicle user.

The more detailed information on V&V here is information more detailed than the information on the V&V in the first notification which is given by S6203 or S6024. For example, a case where the first notification is a notification that the new software is applied to the vehicle system 1a based on the result of the test in which the vehicle user has participated, as illustrated in FIG. 8, is considered. In this case, in the second notification, the notification of a detailed result of the test is given. Specifically, a notification of the actual performance for the evaluation index of the test software corresponding to the new software may be given.

For example, a case where the first notification indicates that the validity of the software is indicated and the validity of the test process is indicated in the test as illustrated in FIG. 9 is considered. In this case, in the second notification, a notification of a detailed reason of validity is given. Specifically, notifications of the process actually executed in the test and the actual performance for the evaluation index of the test software corresponding to the new software may be given. After the process in S6027, the process proceeds to S6028.

In S6028, the driving systems 2A and 2B (for example, the software application unit 81) determine again whether the update consent of the vehicle user has been acquired. If Yes, the process proceeds to S6206, and the update is executed. If No, the process proceeds to S6209, and the update is prohibited.

According to the eighth embodiment described above, when the consent of the vehicle user has not been acquired, the notification of the information on V&V is given in more detail, and the consent is re-requested from the vehicle user. In this way, software with higher validity can be spread by increasing an application rate of the new software so as not to impair the sense of satisfaction of the vehicle user. With this spread, the reliability of the social vehicle system 1a can be improved.

### Ninth Embodiment

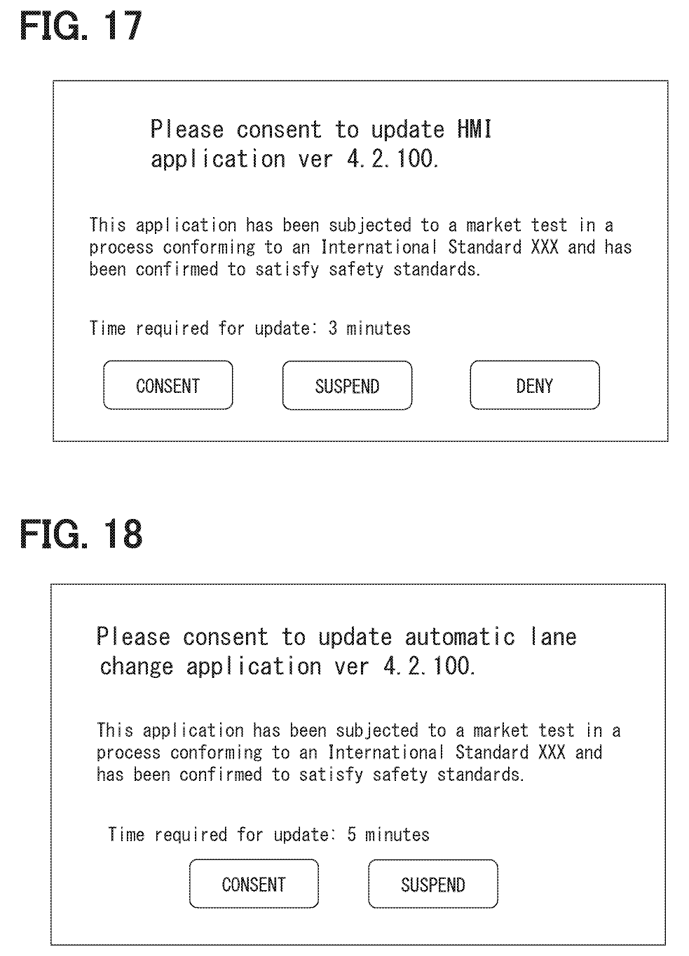

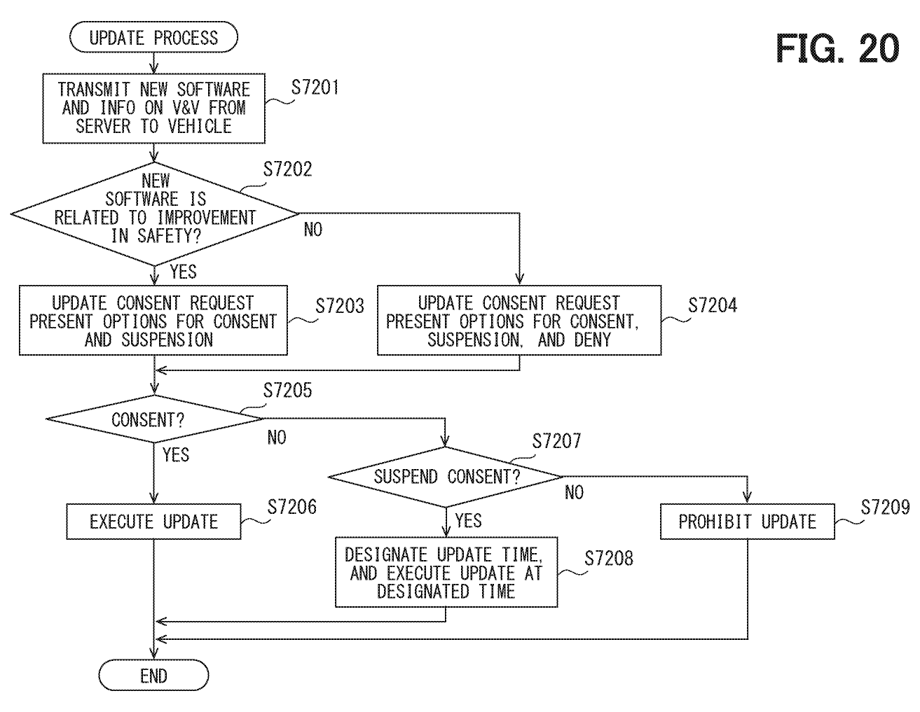

As illustrated in FIGS. 17 and 20, the ninth embodiment is a modification of the first embodiment. The ninth embodiment will be described focusing on differences from the first embodiment.

In the ninth embodiment, it is determined whether the purpose of the update to the new software is related to improvement in safety during traveling. Information indicating the purpose of the update for this determination may be distributed from the server 96, and the determination may be made based on the information on V&V in the driving systems 2A and 2B.

The options of a response presented to the vehicle user in response to the update consent request using the CID 70b2 are changed based on the purpose of the update. Specifically, when it is determined that the purpose is not related to the improvement in safety, the options are presented as three options, consent, suspension, and denying, as illustrated in FIG. 17. On the other hand, when it is determined that the purpose is related to the improvement in safety, the options are presented as two options, consent and suspension, as illustrated in FIG. 18. That is, the improvement in safety is prioritized, and therefore, the vehicle user cannot deny the update.

As illustrated in FIGS. 17 and 18, the time required for the update may be presented together with the presentation of the update request and the information on V&V. The time presented here may be a time generally predicted as the time required for the update, and may be at least one of an average time, a minimum time, and a maximum time in a predicted range.

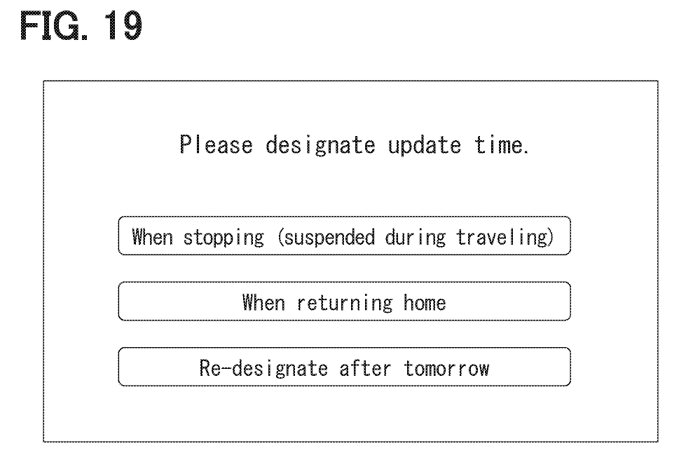

As illustrated in FIG. 19, when the vehicle user selects suspension, it may be requested to designate the update timing using the CID 70b2. The timing of the update that can be designated may be the time of stopping, the time of returning home, or the like. When it is difficult to immediately determine the designation of the timing during the request, the vehicle user may re-designate the timing after a predetermined time or a predetermined date.

When the time of stopping is designated, the update during traveling of the vehicle 1 is prohibited. When it is assumed that the time required for the update is equal to or shorter than the time of stopping for waiting for a traffic light, the update may be started when the vehicle 1 is stopped for waiting for the traffic light. When it is assumed that the time required for the update is longer than the time of stopping for waiting for the traffic light, the update may not be started when the vehicle 1 is stopped for waiting for the traffic light. At a timing of arriving at a destination or during stopping at highway rest areas or the like, the update may be started, which is triggered by connecting, during the stop of the vehicle 1 which is an electric vehicle, a connector from a charging station to a charging port of the vehicle 1. When the time of returning home is designated, it may be determined whether the vehicle 1 has returned home of the vehicle user (driver) by referring to the map data, and the update may be started when it is determined that the vehicle 1 has returned home.

An example of an update method will be described with reference to a flowchart in FIG. 20. In S7201, the server 96 (for example, the software distribution unit 97b) distributes new software to the driving system 2 of each vehicle 1 included in the vehicle population. The server 96 transmits, together with the new software, the information on V&V generated by the server 96 to each of the driving systems 2A and 2B. For example, the information on V&V may include information on the purpose of update. After the process in S7201, the process proceeds to S7202.

In S7202, the driving systems 2A and 2B (for example, the software application unit 81) determine whether the purpose of the update to the new software is related to the improvement in safety. If Yes, the process proceeds to S7203. If No, the process proceeds to S7204.

In S7203, the driving systems 2A and 2B (for example, the HMI cooperation unit 84) conduct, using the HMI device 70, a notification to the vehicle user who is the test participant. Here, the notification includes a notification of an update consent request to the vehicle user for updating the software being applied to the new software and the information on V&V. In the consent request, response options of consent and suspension are given to the vehicle user. After the process in S7203, the process proceeds to S7205.

In S7204, the driving systems 2A and 2B (for example, the HMI cooperation unit 84) conducts, using the HMI device 70, a notification to the vehicle user who is a test participant as in S7203. However, in the consent request, in addition to consent and suspension, a response option of denying is given to the vehicle user. After the process in S7204, the process proceeds to S7205.

In S7205, the driving systems 2A and 2B (for example, the software application unit 81) determine whether the update consent of the vehicle user has been acquired. If Yes, the process proceeds to S7206. If No, the process proceeds to S7207.

In S7206, the driving systems 2A and 2B (for example, the software application unit 81) execute the update to new software. The series of processes is ended after S7206.

In S7207, the driving systems 2A and 2B (for example, the software application unit 81) determine whether the vehicle user suspends the consent. If Yes, the process proceeds to S7208. If No, the process proceeds to S7209.

In S7208, the driving systems 2A and 2B (for example, the software application unit 81) cause the vehicle user to designate a timing of the update, and execute the update at the designated timing. The series of processes is ended after S7208.

In S7209, the driving systems 2A and 2B (for example, the software application unit 81) prohibit the update to new software. The series of processes is ended after S7209.

According to the ninth embodiment described above, the vehicle user can designate an application time of the new software in the consent request. The complexity felt by the vehicle user during the application can be reduced when the new software is applied at any timing by the vehicle user.

According to the ninth embodiment, when the application of the new software relates to the improvement in safety during traveling, the vehicle user cannot deny the consent, and the option of suspending the application is given to the vehicle user in the request for consent. Accordingly, the safety is reliably improved. At the same time, the dissatisfaction of the vehicle user who is forced to apply the new software by the suspended option is reduced, and the reliability of the vehicle user in the vehicle system 1a can be enhanced.

According to the ninth embodiment, the notification of the information on V&V along with the application of the new software and the a period of time required for the application of the new software are presented. When the vehicle user can perceive the time, the reliability of the vehicle user in the vehicle system 1a can be improved.

### Tenth Embodiment

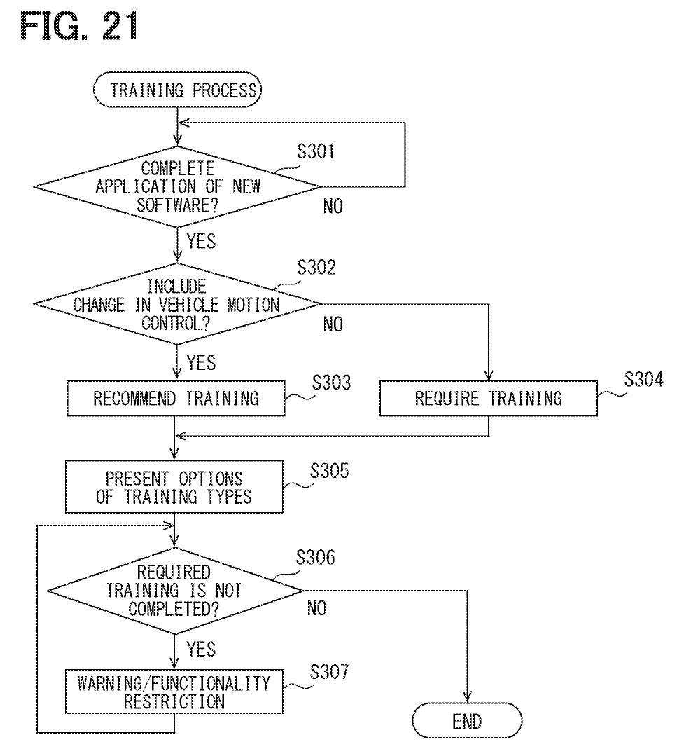

As illustrated in FIG. 21, the tenth embodiment is a modification of the first embodiment. The tenth embodiment will be described focusing on differences from the first embodiment.

The tenth embodiment provides an application that trains the vehicle user to become used to the new software in accordance with the update to the new software. The training application referred to here may be an application that executes a tutorial that allows the vehicle user to experience an operation related to a new application in a simulated manner. The training application may be an application that allows the vehicle user to practice an operation in a real scene. When multiple types of applications can be provided to the vehicle user, the types of applications to be provided to the vehicle user may be presented in a selectable manner.

In the training regarding the new software, the degree of enforcement may be determined as being required or being recommended according to the content of the change by the update to the new software. For example, when the update to the new software includes a change in the HMI, it may be required to conduct training for the vehicle user. On the other hand, when the update to the new software includes a change in a motion control of the vehicle 1, conduction of training for the vehicle user may be recommended.

After the application is provided, the vehicle user may not actually conduct the training. Therefore, a warning for prompting the vehicle user to conduct training may be issued using the HMI device 70 periodically or in response to a predetermined trigger until the vehicle user completes the training. The predetermined trigger may be, for example, immediately after a start switch (for example, an ignition) of the vehicle 1 is turned on. The warning may be conducted, for example, by display using the CID 70b2 or by a voice using a speaker.

Together with or instead of the alarm, the functionality of the new software may be restricted. For example, when it is difficult for the vehicle user to appropriately operate without conducting the training, or when it is difficult to understand the functionality, the functionality may be restricted. Some or all of the functionalities of the new software may be restricted.

An example of a method for providing a training application will be described with reference to a flowchart in FIG. 21. In the first S301, the driving systems 2A and 2B (for example, the software application unit 81) determine whether the update to the new software has been completed. If Yes, the process proceeds to S302. If No, the determination in S301 is conducted again after a predetermined time.

In S302, the driving systems 2A and 2B (for example, the software application unit 81) determine whether the update to the new software includes a change in the motion control of the vehicle 1. If Yes, the process proceeds to S303. If No, the process proceeds to S304.

In S303, the driving systems 2A and 2B (for example, the software application unit 81) determine to recommend training to the vehicle user. On the other hand, in S304, the driving systems 2A and 2B (for example, the software application unit 81) determine that the vehicle user is required (in other words, forced) to be trained. After the processes in S303 and S304, the process proceeds to S305.

In S305, the driving systems 2A and 2B (for example, the HMI cooperation unit 84) present options of types of training provided by the application using the HMI device 70. The vehicle user can start training based on the options. After the process in S305, the process proceeds to S306.

In S306, the driving systems 2A and 2B (for example, the software application unit 81) determine whether the training is required and the vehicle user is in a training incomplete state. If Yes, the process proceeds to S307. If No, the series of processes is ended.

In S307, the driving systems 2A and 2B (for example, the software application unit 81) execute at least one of the warning to the vehicle user and the functionality restriction of the new software. After the process in S307, after a predetermined time or after a predetermined trigger occurs, the process returns to S306. The warning and the functionality restriction here are canceled at a time point when the determination in S306 thereafter becomes No.

According to the tenth embodiment described above, along with the application of the new software, the vehicle user is notified of the information on the training for the new software using the HMI device 70. The vehicle user who has received the notification conducts training to deepen the understanding of the new software, so that the reliability of the vehicle user in the vehicle system 1a can be enhanced.

According to the tenth embodiment, the warning is issued to prompt the vehicle user to conduct the training until the vehicle user completes the training. The avoidance of an untrained state can be promoted, and therefore, the reliability of the vehicle user in the vehicle system 1a can be enhanced.

According to the tenth embodiment, the functionality of the new software is restricted until the vehicle user completes the training. The specific functionality is avoided from being used in a state where the vehicle user does not sufficiently understand or experience the new software, and therefore, the vehicle system 1a can be used at ease.

According to the tenth embodiment, the degree of enforcement of the training for the vehicle user is determined according to the content of the change due to the application of the new software. When the degree of enforcement is flexibly changed according to the content of the change, the annoyance felt by the vehicle user for the training can be reduced.

### Eleventh Embodiment

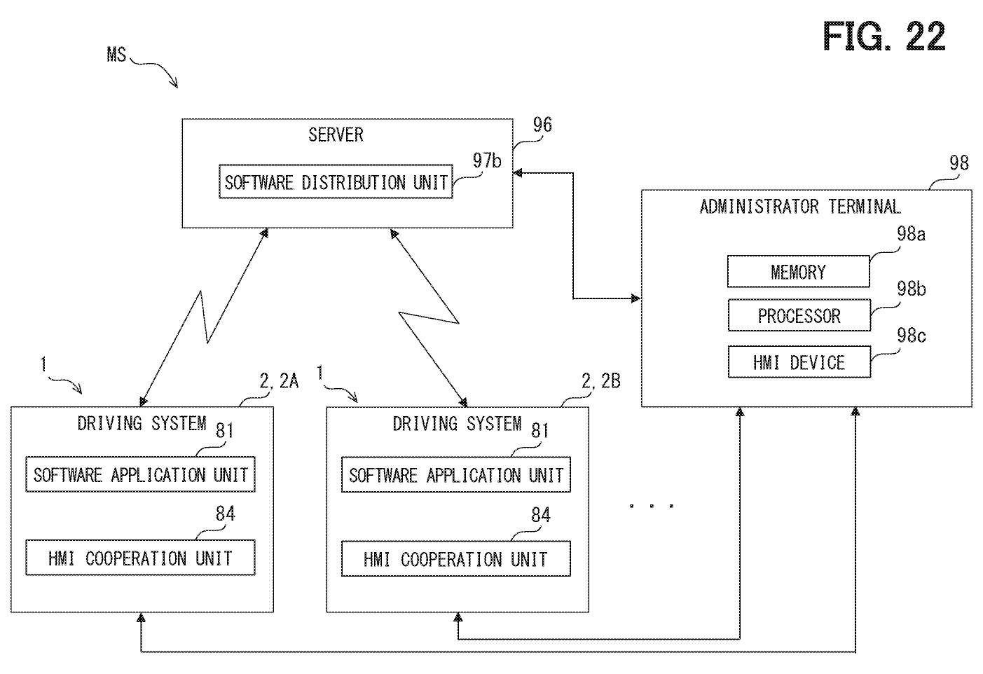

As illustrated in FIGS. 22 to 24, the eleventh embodiment is a modification of the first embodiment. The eleventh embodiment will be described focusing on differences from the first embodiment.

In the eleventh embodiment, the vehicle user includes an administrator who manages the vehicle population. For example, the administrator is a person responsible for vehicle management in a taxi company or a bus company, and the multiple vehicles 1 belonging to the vehicle population may be multiple taxis or buses owned by the taxi company. The taxis and the buses may be manned taxis and buses driven by a driver, or may be self-driving taxis and buses without a driver. For example, the administrator may be a vehicle administrator in a transportation company, and the multiple vehicles 1 belonging to the vehicle population may be multiple trucks or transport vehicles owned by the transportation company.

The eleventh embodiment shows a method in which an administrator can collectively cope with a case where the software of multiple vehicles 1 belonging to a vehicle population is updated. The software may be software distributed through an evaluation process in a market test, or may be software distributed through another evaluation process.

Specifically, as illustrated in FIG. 22, the management system MS further includes an administrator terminal 98 managed by an administrator of the vehicle population. The administrator terminal 98 may be mainly implemented by, for example, a dedicated computer disposed in a company. The administrator terminal 98 is communicably connected to each vehicle 1 by, for example, V2X communication via a communication infrastructure. The administrator terminal 98 is communicably connected to the server 96 via, for example, a communication infrastructure.

In the administrator terminal 98, the dedicated computer includes at least one memory 98a and at least one processor 98b. The memory 98a may be, for example, at least one type of non-transitory tangible storage medium, such as a semiconductor memory, a magnetic medium, and an optical medium, which non-temporarily stores a computer program, data, and the like that can be read by the processor 98b. For example, a rewritable volatile storage medium such as a random access memory (RAM) may be provided as the memory 98a. The processor 98b includes, for example, at least one type of a central processing unit (CPU), a graphics processing unit (GPU), and a reduced instruction set computer (RISC)-CPU as a core.

The administrator terminal 98 may include an HMI device 98c or may be connected to the HMI device 98c. The HMI device 98c may include an information presentation device such as a display, and an operation input device such as a keyboard and a mouse. That is, it can be said that the administrator terminal 98 or the computer thereof is an HMI control device communicably connected to the HMI device 98c.

The server 96 or the administrator terminal 98 can change an update consent method according to whether a target vehicle for which the new software is updated is the entire vehicle population or an individual vehicle. When a vehicle as a new software update target is an individual vehicle, the update consent is individually acquired in the driving systems 2A and 2B in each vehicle 1.

When the vehicle as a new software update target is the entire vehicle population, the update consent is collectively acquired in a vehicle population unit. Specifically, the server 96 requests the administrator terminal 98 to consent to the collective update. Then, in the administrator terminal 98, the processor 98b reads the computer program to execute a process for acquiring the update consent.

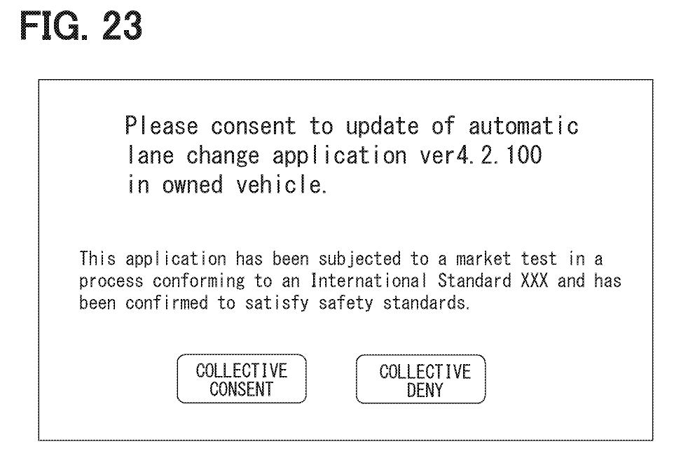

Specifically, as illustrated in FIG. 23, the administrator terminal 98 notifies the administrator as the vehicle user using a display provided as the HMI device 98c. The notification here includes a collective update consent request and notification of information on V&V. In the collective update request, for example, when the administrator clicks a consent icon displayed on the display once, the acquisition of the update consent in all the vehicles 1 of the vehicle population is completed. That is, consent acquisition of the multiple vehicles 1 is implemented by one operation by the administrator.

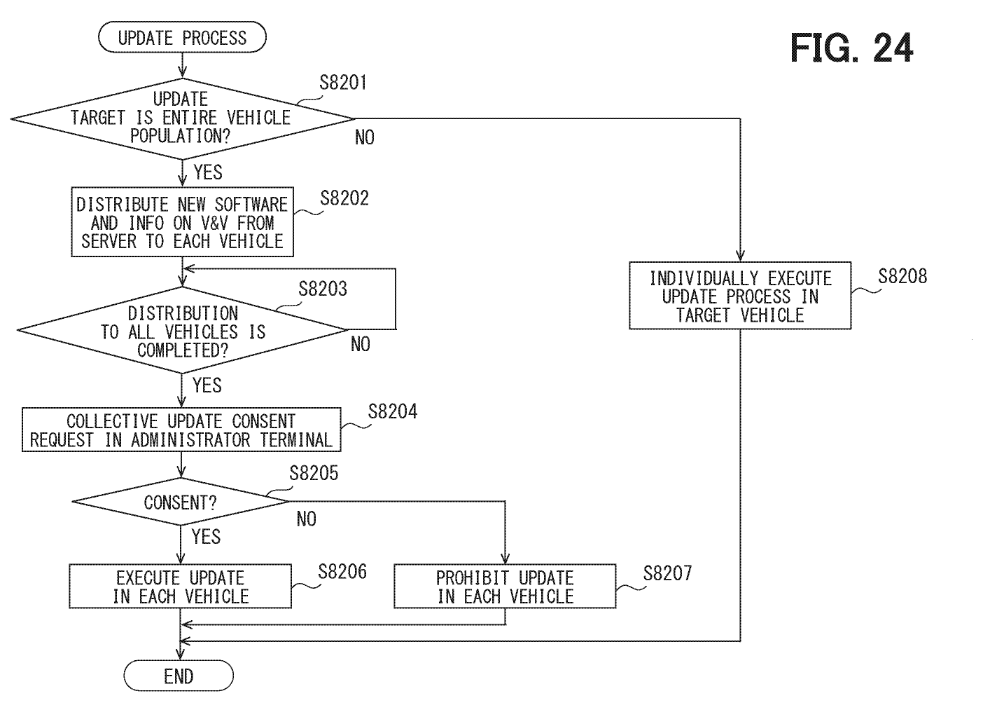

An example of an update method will be described with reference to a flowchart in FIG. 24. In S8201, the server 96 (for example, the software distribution unit 97b) determines whether a target of the update to the new software is the entire vehicle population. If Yes, the process proceeds to S8202. If No, the process proceeds to S8203.

In S8202, the server 96 (for example, the software distribution unit 97b) distributes new software to the driving system 2 of each vehicle 1 included in the vehicle population. The server 96 distributes the information on V&V generated by the server 96 to each of the driving systems 2A and 2B together with the new software. After the process in S8202, the process proceeds to S8203.

In S8203, the server 96 (for example, the software distribution unit 97b) or the administrator terminal 98 determines whether the distribution to all the vehicles 1 in the vehicle population has been completed. If Yes, the process proceeds to S8204. If No, the determination in S8203 is executed again after a predetermined time.

In S8204, the administrator terminal 98 notifies the administrator as the vehicle user using the HMI device 98c. The notification here is a request for acquiring collective update consent in a vehicle population unit. After the process in S8204, the process proceeds to S8205.

In S8205, the administrator terminal 98 determines whether the update consent from the administrator has been acquired. If Yes, the process proceeds to S8206. If No, the process proceeds to S8207.

In S8206, the administrator terminal 98 transmits a request to conduct the update to the new software to the driving systems 2A and 2B of the vehicles 1 belonging to the vehicle population. The driving systems 2A and 2B (for example, the software application unit 81) of each vehicle 1 that has received the conduction request execute the update to the new software. The series of processes is ended after S8206.

In S8207, the administrator terminal 98 transmits a request to prohibit the update to the new software to the driving systems 2A and 2B of the vehicles 1 belonging to the vehicle population. The driving systems 2A and 2B (for example, the software application unit 81) of each vehicle 1 that has received the prohibition request prohibit the update to the new software. The series of processes is ended after S8207.

In S8208 when the determination is No in S8201, the update process is executed individually in each of the update target vehicles. Specifically, the processes illustrated in FIGS. 6, 10, 11, 12, 14, 15, 16, and 20 or an update process according to these processes may be executed. The series of processes is ended after S8208.

According to the eleventh embodiment described above, the application of the new software to the vehicle system 1a is the application of the common new software to the vehicle system 1a included in each of the multiple vehicles 1 belonging to the vehicle population managed by the vehicle user. The consent to the application of the common new software is collectively requested from the vehicle user in the vehicle population units. The vehicle user can collectively consent to multiple vehicles, and therefore, the time and effort of work for the consent can be reduced.

According to the eleventh embodiment, it is confirmed that the new software has been distributed to the vehicle systems 1a of all the vehicles 1 belonging to the vehicle population before the consent is collectively requested in the vehicle population unit. In this way, in each vehicle 1, the new software can be applied immediately after the consent acquisition is completed.

### Other Embodiments

Although multiple embodiments are described above, the present disclosure is not construed as being limited to these embodiments, and can be applied to various embodiments and combinations within a scope that does not depart from the gist of the present disclosure.

As another embodiment, the notification of the information on V&V may be conducted using the HMI device 70 other than the CID 70b2. For example, the notification may be conducted by display on the meter display 70b1 or HUD 70b3, sound from a speaker, or the like. For example, the notification of the information on V&V may be conducted using the mobile terminal 91 or the like owned by the vehicle user other than the HMI device 70 mounted on the vehicle 1.

As another embodiment, in FIGS. 6, 10, 16, and the like, when the update consent is rejected, the driving systems 2A and 2B (for example, the software application unit 81) may transmit information indicating that the consent has been rejected to the server 96. The server 96 (for example, the test software evaluation unit 97d) may collect information from the vehicle population and re-verify whether the evaluation of the test software is correct when a rejection rate of the update consent is higher than a preset threshold. Alternatively, the server 96 (for example, the test software evaluation unit 97d) may notify the test administrator through the HMI of the server 96 that the verification needs to be performed again.

As another embodiment, in the process illustrated in FIG. 24 and the like, instead of the determination of whether the update target is the entire vehicle population, a determination of whether the update target is multiple vehicles or one vehicle among the vehicles belonging to the vehicle population may be adopted. That is, the administrator terminal 98 can collectively execute common consent related to the update to the new software for some and two or more vehicles among the vehicles belonging to the vehicle population.

As another embodiment, in the process illustrated in FIG. 24 and the like, the common consent regarding the update to the new software may be executable by the driving systems 2A and 2B of any vehicle among the multiple vehicles belonging to the vehicle population instead of the administrator terminal 98. In this case, the management system MS may not include the administrator terminal 98.

As another embodiment, the process in FIGS. 20, 21, and the like may be directed to new software distributed through another evaluation process instead of the new software distributed through an evaluation process in a market test.

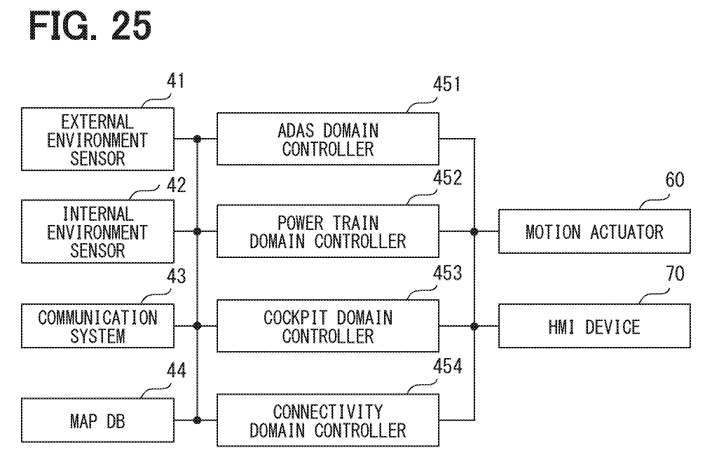

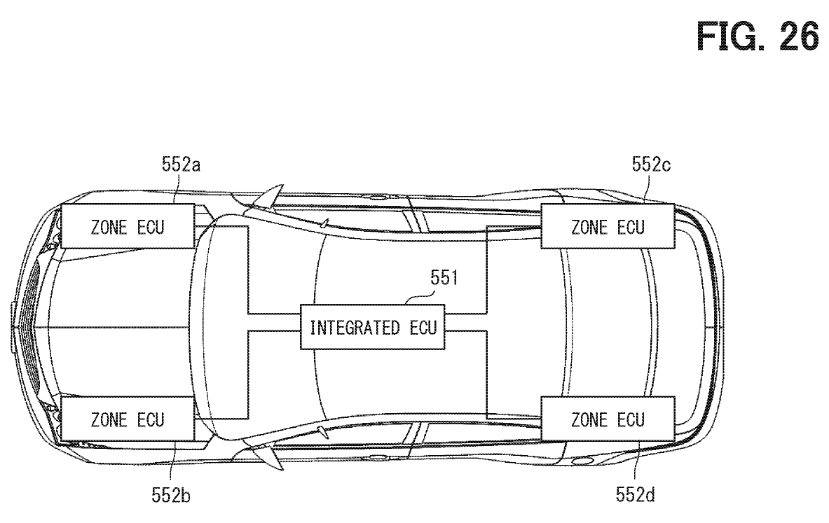

As another embodiment, configurations as illustrated in FIGS. 25 and 26 may be adopted as a configuration of the processing system 50. For example, in FIG. 25, a configuration including multiple domain controllers 451 to 454 is adopted. The domain controllers 451 to 454 may have the same configuration as the processing system or the ECU of the first embodiment.

The ADAS domain controller 451 aggregates functionalities related to advanced driver-assistance systems (ADAS). The ADAS domain controller 451 may implement a part of the perception functionality, a part of the determination functionality, and a part of the control functionality in a combined manner. A part of the perception functionality implemented by the ADAS domain controller 451 may be, for example, a functionality corresponding to fusion of information sensed by the multiple sensors 40 in the sensing unit 10 of the first embodiment or a simplified functionality thereof. A part of the determination functionality implemented by the ADAS domain controller 451 may be, for example, a functionality corresponding to the prediction unit 21 and the driving planning unit 22 of the first embodiment or a simplified functionality thereof. A part of the control functionality implemented by the ADAS domain controller 451 may be, for example, a functionality of generating request information for the motion actuator 60 among the functionalities corresponding to the motion control unit 31 of the first embodiment.

The power train domain controller 452 aggregates functionalities related to control of a power train. The power train domain controller 452 may implement at least a part of the perception functionality and at least a part of the control functionality in a combined manner. A part of the perception functionality implemented by the power train domain controller 452 may be, for example, a functionality of perceiving an operating state of the driver for the motion actuator 60 among functionalities corresponding to the internal perception unit 13 of the first embodiment. A part of the control functionality implemented by the power train domain controller 452 may be, for example, a functionality of controlling the motion actuator 60 among the functionalities corresponding to the motion control unit 31 of the first embodiment.

The cockpit domain controller 453 aggregates functionalities related to cockpit. The cockpit domain controller 453 may implement at least a part of the perception functionality and at least a part of the control functionality in a combined manner. A part of the perception functionality implemented by the cockpit domain controller 453 may be, for example, a functionality of perceiving a switch state of the HMI device 70 in the internal perception unit 13 of the first embodiment. A part of the control functionality implemented by the cockpit domain controller 453 may be, for example, a functionality corresponding to the HMI output unit 71 of the first embodiment.

The connectivity domain controller 454 aggregates functionalities related to connectivity. The connectivity domain controller 454 may implement at least part of the perception functionality in a combined manner. A part of the perception functionality implemented by the connectivity domain controller 454 may be a functionality of organizing and converting global position data, V2X information, and the like of the ego-vehicle acquired from the communication system 43 in the form that can be used by, for example, the ADAS domain controller 451 and the cockpit domain controller 453.

In this embodiment, for example, the cockpit domain controller 453 corresponds to the "HMI control device". When management of software is performed by each of the domain controllers 451 to 454 that implements each functionality, the multiple domain controllers 451 to 454 may correspond to the "HMI control device".

In FIG. 26, a configuration including an integrated ECU 551 and multiple zones ECU 551a to ECU 551d is adopted. In this configuration, the multiple zones ECU 551a to ECU 551d execute control of devices, modules, units, apparatuses, and the like disposed in a predetermined assigned zone of the vehicle 1.

The external environment sensor 41 such as a camera disposed in the front of the vehicle 1 and the information presentation device 70b such as the CID 70b2 disposed in a cockpit are controlled by the zone ECU 551a or the zone ECU 551b disposed in the front of the vehicle 1. For example, the external environment sensor 41 such as a millimeter wave radar disposed on a rear side of the vehicle 1 is controlled by the zone ECU 551c or the zone ECU 551d disposed on the rear side of the vehicle 1.

The integrated ECU 551 aggregates the sensing information and the like from each of the zones ECU 551a to ECU 551d, and performs integrated control of the driving system 2 in each of the zones ECU 551a to ECU 551d. For example, the integrated ECU may implement substantially all of the planning functionality and the software management functionality. In this embodiment, the integrated ECU551 corresponds to an "HMI control device".

As another embodiment, the vehicles 1, TTA, and TTB on which the driving systems 2, 2A, and 2B and the HMI control device are mounted are not limited to general private cars, and may be a rental vehicle, a manned taxi vehicle, a ride-sharing vehicle, a freight vehicle, a bus, and the like. The vehicles 1, TTA, and TTB may be right-hand drive vehicles or left-hand drive vehicles. A traffic environment in which the vehicles 1, TTA, and TTB travel may be a traffic environment in which left-hand traffic is the norm or a traffic environment in which right-hand traffic is the norm. The driving systems 2, 2A, and 2B and the HMI control device according to the present disclosure may be appropriately optimized in consideration of road traffic laws and customs across countries and regions, police investigations, prosecutions, criminal and civil lawsuits regarding traffic accidents, and the like.

The control unit and the method thereof described in the present disclosure may be implemented by a dedicated computer constituting a processor programmed to execute one or multiple functionalities embodied by a computer program. Alternatively, the device and the method thereof according to the present disclosure may be implemented by a dedicated hardware logic circuit. Alternatively, the device and the method thereof according to the present disclosure may be implemented by one or more dedicated computers implemented by a combination of a processor that executes a computer program and one or more hardware logic circuits. The computer program may be stored in a computer-readable non-transitory tangible storage medium, as an instruction executed by a computer.

The present disclosure includes the following technical ideas.

### Technical Idea 1

A human machine interface control device communicably connected to a human machine interface device to be used by a vehicle user, includes at least one of (i) a circuit and (ii) a processor with a memory storing computer program code executable by the processor. The at least one of the circuit and the processor is configured to acquire information on verification and validation of new software that is usable in a vehicle system, and notify, along with application of the new software to the vehicle system, the vehicle user of the information on verification and validation using the human machine interface device.

### Technical Idea 2

In the human machine interface control device according to technical idea 1, the at least one of the circuit and the processor is further configured to notify information on a test of the new software as the information on verification and validation.

### Technical Idea 3

In the human machine interface control device according to technical idea 2, the at least one of the circuit and the processor is further configured to, in response to failing to confirm that the vehicle user is a user participating in the test, notify that validity of the new software has been confirmed by the test as the information on verification and validation.

### Technical Idea 4

In the human machine interface control device according to technical idea 2 or 3, the at least one of the circuit and the processor is further configured to, in response to failing to confirm that the vehicle user is a user participating in the test, notify that validity of a process of the test is indicated as the information on verification and validation.

### Technical Idea 5

In the human machine interface control device according to any one of technical ideas 2 to 4, the at least one of the circuit and the processor is further configured to, in response to confirming that the vehicle user is a user participating in the test, notify, as the information on verification and validation, that the new software is to be applied to the vehicle system based on a result of the test in which the vehicle user participates.

### Technical Idea 6

In the human machine interface control device according to any one of technical ideas 2 to 5, the at least one of the circuit and the processor is further configured to notify an incentive obtained by participating in the test.

### Technical Idea 7

In the human machine interface control device according to any one of technical ideas 2 to 6, the at least one of the circuit and the processor is further configured to, in response to confirming that the vehicle user is a user participating in the test and software corresponding to test software to which a high rating is given by the vehicle user being adopted as the new software, omit consent to application of the new software from the vehicle user.

### Technical Idea 8

In the human machine interface control device according to any one of technical ideas 2 to 6, the at least one of the circuit and the processor is further configured to, in response to confirming that the vehicle user is a user participating in the test and software corresponding to test software to which a low rating is given by the vehicle user being adopted as the new software, notify an inquiry whether to apply the new software to the vehicle system.

### Technical Idea 9

In the human machine interface control device according to any one of technical ideas 2 to 6, and 8, the at least one of the circuit and the processor is further configured to, in response to confirming that the vehicle user is a user participating in the test and software corresponding to test software to which a low rating is given by the vehicle user being adopted as the new software, notify a reason for adopting the new software.

### Technical Idea 10

In the human machine interface control device according to any one of technical ideas 2 to 6, 8, and 9, the at least one of the circuit and the processor is further configured to, in response to confirming that the vehicle user is a user participating in the test and software corresponding to test software to which a high rating is given by the vehicle user being not adopted as the new software, notify a relationship between the test software having the high rating and the new software.

### Technical Idea 11

In the human machine interface control device according to any one of technical ideas 2 to 6 and 8 to 10, the at least one of the circuit and the processor is further configured to, in response to confirming that the vehicle user is a user participating in the test and software corresponding to test software to which a high rating is given by the vehicle user being not adopted as the new software, notify the vehicle user to provide feedback.

### Technical Idea 12

In the human machine interface control device according to any one of technical ideas 2 to 11, the at least one of the circuit and the processor is further configured to, when test software used in the test and the new software include a common user setting element, reflect the user setting element set during the test in the new software along with the application of the new software to the vehicle system.

### Technical Idea 13

In the human machine interface control device according to any one of technical ideas 7 to 12, the at least one of the circuit and the processor is further configured to, when an interval between a conduction time of the test and a distribution time of the new software is equal to or longer than a predetermined period, notify a relationship between test software and the new software.

### Technical Idea 14

In the human machine interface control device according to any one of technical ideas 2 to 13, the at least one of the circuit and the processor is further configured to, when an interval between a conduction time of the test and a distribution time of the new software is shorter than a predetermined period, cancel notifying of the information on verification and validation.

### Technical Idea 15

In the HMI control device according to any one of technical ideas 1 to 14, the at least one of the circuit and the processor is further configured to execute, together with the notifying, requesting the vehicle user to consent to apply the new software, and execute, when the consent of the vehicle user has not been acquired, giving a notification of the information on V&V again in more detail and re-requesting the consent from the vehicle user.

### Technical Idea 16

In the HMI control device according to any one of technical ideas 1 to 14, the at least one of the circuit and the processor is further configured to execute, together with the notifying, requesting the vehicle user to consent to application of the new software.

### Technical Idea 17

In the HMI control device according to technical idea 16, the at least one of the circuit and the processor is further configured to execute, when the consent of the vehicle user has not been acquired, giving a notification of the information on V&V again in more detail, and re-requesting the consent from the vehicle user.

### Technical Idea 18

In the HMI control device according to technical idea 16 or 17, the at least one of the circuit and the processor is further configured to enable the vehicle user to designate an application time of the new software in requesting the consent.

(Technical Idea 19)

In the HMI control device according to any one of technical ideas 16 to 18, the at least one of the circuit and the processor is further configured to, when application of the new software relates to improvement in safety, in requesting consent, disable the vehicle user from denying the consent and gives the vehicle user an option of suspending the application.

### Technical Idea 20

In the HMI control device according to any one of technical ideas 1 to 19, the at least one of the circuit and the processor is further configured to present, together with the notifying, a period of time required to apply the new software.

### Technical Idea 21

In the HMI control device according to any one of technical ideas 1 to 20, the at least one of the circuit and the processor is further configured to execute, along with application of the new software, notifying the vehicle user of information on training for the new software by using the HMI device.

### Technical Idea 22

In the HMI control device according to technical idea 21, the at least one of the circuit and the processor is further configured to execute issuing a warning to prompt conduction of the training until the vehicle user completes the training.

### Technical Idea 23

In the HMI control device according to technical idea 21 or 22, the at least one of the circuit and the processor is further configured to execute restricting a functionality of the new software until the vehicle user completes the training.

### Technical Idea 24

In the HMI control device according to any one of technical ideas 21 to 23, the at least one of the circuit and the processor is further configured to execute determining a degree of enforcement on the vehicle user to conduct the training according to content of change due to application of the new software.

### Technical Idea 25

In the HMI control device according to technical idea 1, the application of the new software to the vehicle system is application of common new software to the vehicle system provided in each of a plurality of vehicles belonging to a vehicle population managed by the vehicle user. The at least one of the circuit and the processor is further configured to execute, together with the notifying, collectively requesting the vehicle user to consent to the application of the common new software in units of the vehicle population.

### Technical Idea 26

In the HMI control device according to technical idea 25, the at least one of the circuit and the processor is further configured to execute, before collectively requesting the consent in units of the vehicle population, confirming that the new software has been distributed to the vehicle systems of all the vehicles belonging to the vehicle population.

### Technical Idea 27

A management system for managing software usable in a vehicle system includes multiple vehicles each equipped with the vehicle system; and a server communicably connected to the multiple vehicles. The server is configured to perform: executing a V&V process of the software usable in the vehicle system; generating information on the V&V of the software based on the V&V process; and transmitting the information on the V&V to each of the vehicles along with distribution of new software to each of the vehicles, the new software being determined to be formally distributed based on the execution of the V&V process. At least one of the vehicle systems is configured to execute: acquiring information on the V&V; and notifying a vehicle user of the information on the V&V using an HMI device used by the vehicle user along with application of the new software to the vehicle system.

### Technical Idea 28

A server communicably connected to a plurality of vehicles each equipped with a vehicle system, includes at least one processor. The at least one processor is configured to perform: executing a V&V process of software usable in the vehicle system; generating information on the V&V of the software; and transmitting the information on the V&V to each of the vehicles along with distribution of new software to each of the vehicles, the new software being determined to be formally distributed based on the execution of the V&V process.

According to this technical idea, the vehicle user can perceive the validity of the new software used in the vehicle system through the information on V&V acquired on each vehicle side. Therefore, the reliability of the vehicle user in the vehicle system can be enhanced, and the vehicle system can be used at ease.

### Technical Idea 29

A method for generating, along with application of new software to a vehicle system, data to be provided to a vehicle user is provided. The method is executed by at least one processor to perform: evaluating test software corresponding to the new software based on a V&V process; and generating information on V&V of the new software in a form suitable for provision to the vehicle user based on an evaluation result.

According to this technical idea, the vehicle user can perceive the validity of the new software used in the vehicle system through the generated information on V&V provided to the vehicle user. Therefore, the reliability of the vehicle user in the vehicle system can be enhanced, and the vehicle system can be used at ease.

What is claimed is:

1. A human machine interface control device, which is communicably connected to a human machine interface device to be used by a vehicle user, comprising:
at least one of (i) a circuit and (ii) a processor with a memory storing computer program code executable by the processor, the at least one of the circuit and the processor configured to:
acquire information on verification and validation of new software that is usable in a vehicle system; and
notify, along with application of the new software to the vehicle system, the vehicle user of the information on verification and validation using the human machine interface device.

2. The human machine interface control device according to claim 1, wherein the at least one of the circuit and the processor is further configured to
notify information on a test of the new software as the information on verification and validation.

3. The human machine interface control device according to claim 2, wherein the at least one of the circuit and the processor is further configured to,
in response to failing to confirm that the vehicle user is a user participating in the test, notify that validity of the new software has been confirmed by the test as the information on verification and validation.

4. The human machine interface control device according to claim 2, wherein the at least one of the circuit and the processor is further configured to,
in response to failing to confirm that the vehicle user is a user participating in the test, notify that validity of a process of the test is indicated as the information on verification and validation.

5. The human machine interface control device according to claim 2, wherein the at least one of the circuit and the processor is further configured to,
in response to confirming that the vehicle user is a user participating in the test, notify, as the information on verification and validation, that the new software is to be applied to the vehicle system based on a result of the test in which the vehicle user participates.

6. The human machine interface control device according to claim 2, wherein the at least one of the circuit and the processor is further configured to
notify an incentive obtained by participating in the test.

7. The human machine interface control device according to claim 2, wherein the at least one of the circuit and the processor is further configured to,
in response to confirming that the vehicle user is a user participating in the test and software corresponding to test software to which a high rating is given by the vehicle user being adopted as the new software, omit consent to application of the new software from the vehicle user.

8. The human machine interface control device according to claim 2, wherein the at least one of the circuit and the processor is further configured to,
in response to confirming that the vehicle user is a user participating in the test and software corresponding to test software to which a low rating is given by the vehicle user being adopted as the new software, notify an inquiry whether to apply the new software to the vehicle system.

9. The human machine interface control device according to claim 2, wherein the at least one of the circuit and the processor is further configured to,
in response to confirming that the vehicle user is a user participating in the test and software corresponding to test software to which a low rating is given by the vehicle user being adopted as the new software, notify a reason for adopting the new software.

10. The human machine interface control device according to claim 2, wherein the at least one of the circuit and the processor is further configured to,
in response to confirming that the vehicle user is a user participating in the test and software corresponding to test software to which a high rating is given by the vehicle user being not adopted as the new software, notify a relationship between the test software having the high rating and the new software.

11. The human machine interface control device according to claim 2, wherein the at least one of the circuit and the processor is further configured to,
in response to confirming that the vehicle user is a user participating in the test and software corresponding to test software to which a high rating is given by the vehicle user being not adopted as the new software, notify the vehicle user to provide feedback.

12. The human machine interface control device according to claim 2, wherein the at least one of the circuit and the processor is further configured to,
when test software used in the test and the new software include a common user setting element, reflect the user setting element set during the test in the new software along with the application of the new software to the vehicle system.

13. The human machine interface control device according to claim 2, wherein the at least one of the circuit and the processor is further configured to,
when an interval between a conduction time of the test and a distribution time of the new software is equal to or longer than a predetermined period, notify a relationship between test software and the new software.

14. The human machine interface control device according to claim 2, wherein the at least one of the circuit and the processor is further configured to,
when an interval between a conduction time of the test and a distribution time of the new software is shorter than a predetermined period, cancel notifying of the information on verification and validation.

15. The human machine interface control device according to claim 1, wherein the at least one of the circuit and the processor is further configured to,
in addition to notifying of the information on verification and validation, request the vehicle user to consent to application of the new software.

16. The human machine interface control device according to claim 15, wherein the at least one of the circuit and the processor is further configured to,
in response to a consent of the vehicle user being not acquired, notify the information on verification and validation again in more detail, and request the vehicle user again to consent to application of the new software.

17. The human machine interface control device according to claim 15, wherein the at least one of the circuit and the processor is further configured to
enable the vehicle user to designate an application time of the new software in requesting of the consent.

18. The human machine interface control device according to claim 15, wherein the at least one of the circuit and the processor is further configured to,
when application of the new software relates to improvement in safety, disable the vehicle user from denying the consent and give the vehicle user an option of suspending the application of the new software in requesting of the consent.

19. The human machine interface control device according to claim 1, wherein the at least one of the circuit and the processor is further configured to
present, together with notifying of the information on verification and validation, a period of time required to apply the new software.

20. The human machine interface control device according to claim 1, wherein the at least one of the circuit and the processor is further configured to,
along with application of the new software, notify the vehicle user about information on training of the new software using the human machine interface device.

21. The human machine interface control device according to claim 20, wherein the at least one of the circuit and the processor is further configured to
issue a warning to prompt conduction of the training of the new software until the vehicle user completes the training of the new software.

22. The human machine interface control device according to claim 20, wherein the at least one of the circuit and the processor is further configured to
restrict a functionality of the new software until the vehicle user completes the training of the new software.

23. The human machine interface control device according to claim 20, wherein the at least one of the circuit and the processor is further configured to
determine a degree of enforcement on the vehicle user to conduct the training of the new software according to change of content due to application of the new software.

24. The human machine interface control device according to claim 1, wherein
the application of the new software to the vehicle system is application of common new software to the vehicle system provided in each of a plurality of vehicles belonging to a vehicle population managed by the vehicle user, and
the at least one of the circuit and the processor is further configured to, together with notifying of the information on verification and validation, collectively request the vehicle user to consent to the application of the common new software in units of the vehicle population.

25. The human machine interface control device according to claim 24, wherein the at least one of the circuit and the processor is further configured to,
before collectively requesting for the consent in units of the vehicle population, perform a confirmation that the new software is distributed to the vehicle systems of all the vehicles belonging to the vehicle population.

26. A management system for managing software usable in a vehicle system, the management system comprising:
a plurality of vehicles each equipped with the vehicle system; and
a server communicably connected to the plurality of vehicles,
wherein
the server is configured to:
execute a process related to verification and validation of the software usable in the vehicle system;
generate information on verification and validation of the software based on the process related to verification and validation; and
transmit the information on verification and validation of the software to each of the plurality of vehicles along with distribution of new software, the new software being determined to be formally distributed to each of the plurality of vehicles based on execution of the process related to verification and validation, and
the vehicle system equipped in at least one of the plurality of vehicles is configured to:
acquire the information on verification and validation; and
along with application of the new software to the vehicle system, notify a vehicle user of the information on verification and validation using a human machine interface device that is used by the vehicle user.
